(19) United States
(12) Patent Application Publication
(10) Pub. No.: US 2004/0072604 A1
(43) Pub. Date: Apr. 15, 2004

(54) Gaming machine, program and server

(75) Inventor: Hirobumi Toyoda, Tokyo (JP)

Correspondence Address: ALFRED A. STADNICKI, ANTONELLI, TERRY, STOUT & KRAUS, LLP, SUITE 1800, ARLINGTON, VA, 22209, US

(73) Assignee: ARUZE CO. LTD., TOKYO (JP)

(21) Appl. No.: 10/612,306

(22) Filed: Jul. 3, 2003

(30) Foreign Application Priority Data
Jul. 4, 2002 (JP) 2002-196373

(51) Int. Cl. A63F 13/00

(52) U.S. Cl. 463/16

(57) ABSTRACT

In a bingo game or other game using a matrix card, a gaming machine is provided to which is added an element that enables a player to make a selection that can influence the game result. The designs of playing cards, etc. are used in the respective cells of a matrix card and profit is provided to a player only when all cells of a single line are made effective by lottery and a winning combination of a poker game, etc. is formed on this line.

### CROSS-REFERENCE TO RELATED APPLICATIONS

This application is based upon and claims the benefit of priority from the prior Japanese Patent Application No. 2002-196373 filed on Jul. 4th in 2002, the entire contents of which are incorporated herein by reference.

This application is related to co-pending U.S. patent applications entitled “Gaming Machine, Server and Program for Plural Players” and “Gaming Machine, Server and Program for Card Game”, respectively, both applications being filed on even date herewith. The co-pending applications are expressly incorporated herein by reference.

### BACKGROUND OF THE INVENTION

1. FIELD OF THE INVENTION

This invention relates to a gaming machine, a program, and a server.

2. RELATED ART

A “bingo game” is played in parties and other events. In the “bingo game,” a card forming a matrix which has some numerals from 1 to 75 allocated to respective cells of the matrix with five rows aligned vertically and five columns aligned horizontally is used. In accordance with selection by a lottery, a hole is made in each cell if an allocated number to the cell matches a selected number at each lottery occasion so that a card holder wins the game if his card has holes made along a vertical, horizontal, or diagonal line first.

This “bingo game” is simple in rules and, unlike lottery methods with which the results become known in an instant, it provides such effects as “keeping one in suspense” when a hole cannot be opened quickly and the “anticipation” of completing a row with just one more hole, and is thus enjoyed by many people regardless of age or gender.

While “bingo cards” made of paper are usually used when the bingo game is played at a party, various computer gaming machines simulating the game have also been developed and are installed in many gaming halls and arcades.

The gaming machine, etc. described in Japanese Unexamined Patent Publication No. 2001-162046 can be given as an example of a bingo gaming machine that is installed in a game hall.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc. It can thus be said that most players select cards randomly.

Strategy and other thought processes for influencing the result are thus unnecessary for a player playing a bingo game and a player thus leaves the game result up to luck. It is therefore not an overstatement to say that a player simply enjoys the process leading up to the result.

Although some entertainment may be made during such process, it can be readily imagined that there is popularity of various games that allow players to utilize their own skills even if they can affect the game result only to a small degree.

### SUMMARY OF THE INVENTION

It is an object to provide a gaming machine that provides a game like a bingo game using a matrix card so as to add an element to enable a player to make a selection that can influence the game result.

It is an object of the present invention to provide a gaming machine that let a player play a game using a matrix card, wherein some designs of a deck of playing cards are utilized in the respective cells of the matrix card and the game is won only when all cells of a single line of the matrix card are selected and made effective by lotteries and a winning combination of a poker game, by way of example, is formed along the line.

More specifically , this invention provides the following.

(1) There is provided a gaming machine with which a combination-making game using a matrix that comprises a row with a row cell number of at least two and a column with a column cell number of at least two is performed, wherein the row cell number equals the column cell number so as to constitute the matrix containing a plurality of cells, each of which has an allocated symbol such that each corresponding cell becomes effective if the allocated symbol to the corresponding cell is selected by a main lottery. The gaming machine is characterized to provide a benefit to a player depending on a pattern of cells being effective after a predetermined number of main lotteries so that it comprises: a symbol allocating means for allocating symbols to the respective cells such that at least one combination being composed of a same number of symbols as the row or column cell number matches a first predetermined winning combination with a first predetermined rank of the combination-making game under a predetermined condition so that the at least one combination is aligned along a first line among lines contained in the matrix; and a disbursement value determination means for determining amount of disbursement or a multiple number of a bet number of bets made by the player for disbursement depending on the first predetermined rank of the combination of the combination-making game if all cells with allocated symbols along the first line so as to make the first winning combination become effective after the predetermined number of lotteries are made with the matrix having symbols allocated to the respective cells thereof.

(2) The gaming machine according to (1) is characterized in that the combination-making game comprises a poker game and the row cell number of the matrix is five.

According to the present invention, a gaming machine is provided such that the gaming machine provides a benefit to a player based on patterns of cells that are made effective as results of lotteries repeated a predetermined number of times wherein the gaming machine utilizes a matrix comprising five rows and five columns such that each cell of the matrix has an allocated symbol. Thus, the matrix may be defined by the row cell number of five and the column cell number of five. When a symbol selected randomly by each lottery matches a symbol allocated to one of the cells, the matching cell becomes effective. The lottery may be repeated for a predetermined number of times or until any one wins the game such that the effective cells form patterns including a predetermined line such as a vertical line of five cells, a horizontal line of five cells, a diagonal line of five cells, or another special line.

The gaming machine comprises: a symbol allocating means, which uses the designs of a deck of playing cards as the symbols and allocates some symbols in all cells of the matrix respectively so that a combination among a plurality of combinations of the designs that are same as poker hands with some rank or winning combinations will be lined in at least one or more lines contained in the matrix; and a disbursement value determination means, which determines amount of disbursement or a magnitude of disbursement of game media or a multiplication factor of disbursement with respect to the number of game media bet by the player in accordance with the combination when all cells of the line making a poker hand with some rank or a winning combination become effective as the game is carried out using the matrix having symbols allocated to all cells by the symbol allocating means.

According to the present invention, a gaming machine, such as a so-called “bingo gaming machine,” which makes effective cells of the matrix a player holds as the lottery is repeated, comprises: a symbol allocating means, which uses the designs of a deck of playing cards as the symbols and allocates some symbols in all cells of the matrix respectively so that a combination among a plurality of combinations of the designs that are same as poker hands with some ranks or winning combinations will be lined in at least one or more lines contained in the matrix; and a disbursement value determination means, which determines amount of disbursement or a magnitude of disbursement of game media or a multiplication factor of disbursement with respect to the number of game media bet by the player in accordance with the combination when all cells of the line making a poker hand with some rank or a winning combination become effective as the game is carried out using the matrix having symbols allocated to all cells by the symbol allocating means. Therefore, fun of the “bingo game” that the player anticipates whether or not a line of effective cells will be completed and fun of the “poker game” that the number of game media disbursed is determined by the player's combination formed with effective cells are combined, thereby enabling a new way of enjoying the game in which the aim is not just to complete any line among the plurality of lines in a “bingo game” but in which the number of game media disbursed is determined by what winning combination the completed line has.

Since “bingo games” have been played in parties and other events and are simple in rules, the games have been enjoyed by many people regardless of age or gender. Though in an event, “bingo cards” made of paper are used in the “bingo game,” various computer gaming machines simulating the game have also been developed and are installed in many game halls and arcades.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc. It can thus be said that most players select cards randomly.

Thus as in the present invention, by arranging a game to proceed using the designs of a deck of playing cards in place of the numbers in the conventional “bingo game” and arranging so that when a line is completed and the combination of the corresponding symbols form a winning combination of a “poker game,” the quantity or number of game media disbursed is determined in accordance with this winning combination, the decision of a player at the point of selecting a card can be made to influence the game result.

For example, the player may make a judgment when the player selects a matrix card with combinations of symbols, which include ‘royal straight flush,’ combination in some line, since a large number of game media may be disbursed if the line is completed even though the completion of the line seems to be difficult. Or the player may select a card having lines of poker hands with lower ranks although the disbursement amount is small but it is more likely to have one line completed than the case with only single line has a higher poker hand with a higher rank which makes a larger disbursement since the completion of the line seems difficult.

It is also possible to make the player feel the same sort of anticipation as that in a poker game, that is, for example, when four cells of a certain line have been made effective and a win will be achieved when the remaining cell becomes effective, the player can feel the anticipation that “the ‘royal straight flush’ will be completed if an ace of hearts becomes effective next.”

Furthermore, since symbols are allocated to all cells of the matrix so that a combination among a plurality of designs that are poker hands with some ranks or winning combinations in a poker game will be lined in at least one line contained in the matrix, a matrix having no winning combination will not be assigned to a player. The player therefore can anticipate receiving a benefit no matter which card the player selects.

(3) The gaming machine according to (1) is characterized in that the combination-making game comprises a mahjong game.

According to the present invention, a gaming machine is provided, wherein a symbol is indicated in each cell of a matrix with the number of cells making up a row and the same number of cells making up a column, a cell becomes effective if a symbol allocated to the cell matches a symbol which is selected randomly by a lottery, and the gaming machine provides a predetermined benefit to a player in accordance with conditions of effective cells as a result of the lottery repeated for a predetermined number of times. The gaming machine comprises: a symbol allocating means, which uses the designs of a set of mahjong tiles as the above-mentioned symbols and allocates symbols to all cells of the above-mentioned matrix so that a combination, among a plurality of combinations of the above-mentioned designs that are the same as winning combinations made up of predetermined combinations of symbols, will be lined in at least one line contained in the above-mentioned matrix; and a disbursement value determination means, which determines, in accordance with the above-mentioned winning combination, the magnitude of disbursement of game media or the multiplication factor of disbursement with respect to the quantity or number of game media bet by the above-mentioned player when all cells of one line that indicate a combination of symbols expressing the above-mentioned predetermined winning combination become effective, as the game is carried out using the matrix having symbols allocated to all cells by the above-mentioned symbol allocating means.

With the above description, since a gaming machine, such as a so-called “bingo gaming machine,” in which cells of the matrix assigned to the player are made effective in accordance with the lottery, so as to “have a symbol allocating means, which uses the designs of a set of mahjong tiles as the above-mentioned symbols and allocates symbols to all cells of the above-mentioned matrix so that a combination, among a plurality of combinations of the above-mentioned designs that are the same as winning combinations made of predetermined combinations of symbols, will be lined in at least one line of the above-mentioned matrix; and a disbursement value determination means, which determines, in accordance with the above-mentioned winning combination, the magnitude of disbursement of game media or the multiplication factor of disbursement with respect to the quantity of game media bet by the above-mentioned player when all cells of a line, made of cells that indicate a combination of symbols expressing an above-mentioned predetermined winning combination, become effective, as the game is carried out using the matrix having symbols allocated to all cells by the above-mentioned symbol allocating means, fun of a “bingo game” that the player anticipates whether or not a line of effective cells will be completed and fun of a “mahjong game” that the player anticipates some quantity or number of game media disbursed being determined according to a winning combination formed by a combination of symbols indicated by the effective cells, thereby enabling a new way of enjoying the game in which the quantity of game media disbursed is determined by what winning combination the completed has, and also enabling a new gaming machine that differs in design and in the combinations of symbols that form a winning combination from the above case of the poker game.

A “bingo game” has been played in parties and other events, and because of simplicity in rules many people regardless of age or gender enjoy the game. Though in an event, “bingo cards,” made of paper, are usually used in the bingo game, various computer gaming machines simulating the game have also been developed and are installed in many game halls and arcades.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc. It can thus be said that most players select cards randomly.

According to the present invention, a game may proceed using some designs of a set of mahjong tiles in place of the numerals in the conventional “bingo game.” For example, an eight-row by eight-column matrix may be used so that when a line is completed, a combination with some rank in associated with a winning combination of the mahjong game, which is composed of two sets of three symbols with mutual relationships and one set of two symbols of the same kind, determines the quantity or number of game media to be disbursed in accordance with a predetermined winning combination. Thus, the decision of the player at the point of selecting a card can be made to influence the game result.

For example, such judgments as “selecting a card wherein a combination of symbols, which makes a ‘One Suit,’ forms a line since a larger amount of game media will be disbursed if the line is completed even though the completion of the line may be less likely,” or “selecting a card having a line made of a winning combination that is small in the quantity to be disbursed but seems to be more readily completed since the completion of a line of a winning combination of a large quantity to be disbursed seems difficult,” etc. can be made.

It is also possible to make the player feel the same sort of anticipation as that in a mahjong game, that is for example, when seven cells in a certain line are made effective and a win is to be achieved with one remaining cell becoming effective, the player can feel the anticipation that “a ‘One Suit’ will be completed if a single ball tile becomes effective next.”

Furthermore, since symbols are allocated to all cells of the above-mentioned matrix so that a combination, among a plurality of combinations of the above-mentioned designs that are the same as the winning combinations made of predetermined combinations of symbols, will be lined in at least one line of the above-mentioned matrix, a matrix with no winning combination of symbols will not be assigned to the player. Therefore, the player can anticipate receiving a benefit no matter which card the player selects.

(4) The gaming machine according to any one from (1) to (3), further comprising a betting means for betting game media in regard to the matrix, wherein the first winning combination that is aligned along the first line and is composed of symbols allocated by said symbol allocating means causes the gaming machine to provide a benefit to the player and the benefit, which is more than a predetermined standard, is based on a disbursable number of the game media or the multiple number of the bet number of the game media the player has bet.

According to the present invention, the above-described gaming machine is characterized in that the gaming machine provides a benefit or makes a disbursement to the player as much quantity of game media to be disbursed or a multiplication factor of disbursement with respect to the quantity of game media bet by the player such that the player may expect disbursement of a predetermined standard or even more when a winning combination that is lined along at least one line contained in the matrix by the above-mentioned symbol allocating means is contained in the player's matrix card.

According to the present invention, the above-described gaming machine is provided so that the gaming machine provides the player with a benefit of a quantity of game media disbursed or a multiplication factor of disbursement with respect to the quantity of game media bet by the above-mentioned player because of a winning combination that is lined along at least one line contained in the matrix by the above-mentioned symbol allocating means so that the payout may be a predetermined standard or more. Therefore, it may be possible for the player to always anticipate the provision of benefit of a certain level or more.

With the above-described gaming machine, a matrix assigned to the player is always arranged so that at least one winning combination can be completed and such winning combination includes “one pair,” “two pairs,” and other winning combinations that are low in the quantity of game media to be disbursed or low in the multiplication factor of disbursement with respect to the quantity of game media bet by the above-mentioned player. In the present invention, a winning combination, which enables the provision of benefit to the above-mentioned player in the form of a quantity of game media to be disbursed or a multiplication factor of disbursement with respect to the quantity of game media bet by the above-mentioned player, who may expect a predetermined standard or more, will always be included in the matrix assigned to the above-mentioned player. Therefore, it becomes possible for the player to anticipate the provision of benefit of the certain level or more no matter which card the player chooses and the player's interest can thus be drawn further.

(5) The gaming machine according to (4) is characterized in that said symbol allocating means allocates symbols to the respective cells of the matrix such that the matrix contains a second line being constituted of a second combination with a second rank of the combination-making game; wherein said betting means allows the player to bet game media on the first and/or second lines; and wherein the gaming machine comprises an effective line determination means for determining whether the first and/or second lines are applicable to disbursement of game media in accordance with a bet number of game media the player has bet if all cells of the first and second lines become effective.

According to the present invention, the above-described gaming machine comprises an effective line determination means, which determines the number and location of lines among the above-mentioned plurality of lines in accordance with the quantity of game media bet by the player such that disbursement of game media can be carried out when all cells lined in such lines become effective.

According to the present invention, the above-described gaming machine comprises an effective line determination means, which determines, in accordance with the quantity of game media bet by the player, the number and positions of lines among the above-mentioned plurality of lines, with which disbursement of game media can be carried out when all cells aligned therein become effective. Therefore, it becomes possible to select the number of lines subject to betting in accordance with the quantity of game media bet by a player and adjust the quantity of game media bet in accordance with the magnitude of the multiplication factor of disbursement upon completion of the lines, thus enabling the selection by the player to have a large influence on the game result.

With a conventional “bingo game,” it was sufficient for any one of the vertical, horizontal, and diagonal lines to be completed.

However, with the game according to the present invention, since the multiplication factor of disbursement of game media varies by completion of a line and a combination of symbols in the completed line, each line may have a different value to each player such that some players prefer a high disbursement multiplication factor, lines with which a low disbursement multiplication factor, and lines with which no disbursement, and so on.

Thus with this invention, by making not the entirety of a single matrix be a subject of betting but by making each line among a plurality of lines in a single matrix be a subject of betting, the ranges of a player's selection and strategy are expanded and the provision of a gaming machine that is more interesting is enabled.

For example, a selection, such as betting a single coin on a line having a “four card” as a winning combination, betting five coins on a line having a “two pairs” as a winning combination, and not betting even a single coin on another line having a “one pair” as a winning combination, is enabled.

(6) The gaming machine according to any one from (1) to (5) further comprises a preliminary cell validation means for making at least one cell contained in the matrix effective in accordance with a result of a preliminary lottery performed prior to said main lottery.

According to the present invention, the above-described gaming machine comprises a preliminary cell validation means, which makes some of the cells of the above-mentioned matrix effective in advance, in accordance with a lottery or preliminary lottery.

With this invention, the above-described gaming machine comprises a preliminary cell validation means, which makes one or more of the cells of the above-mentioned matrix effective in accordance by a preliminary lottery. Therefore, the shortening of the game time by quick completion of a line can be anticipated and the player can be made to anticipate ease-of completion of a certain of predetermined line.

In the original “poker game,” with the exception of special winning combinations, there are various hand card combinations that can make a winning combination. For example, in the case of “two pairs,” as long as the four cards that form two pairs are determined, the remaining card may be any card.

However, with the game according to the present invention, since the allocation of the symbols are determined in advance and since all of the symbols indicated in five cells of a line must be made effective no matter what winning combination the combination along the line forms, a large number of lotteries is required to complete a line.

Thus with this invention, by making one or more of the cells effective by a preliminary lottery in advance and thereby enabling the line, having these cells that have been made effective, to be completed by the making effective the cells besides these effective cells, the shortening of the game time can be anticipated. Also a player can be made to anticipate early completion of the line, thus enabling the interest of the player to be drawn.

Also since in the case where the designs of mahjong tiles are used, the number of cells can become comparatively large, the above arrangement enables the progress of the game to be quickened.

According to the present invention, a gaming machine is provided, wherein a symbol is indicated in each of the cells of a matrix comprising five rows and five columns and with which when a symbol selected randomly by a lottery matches a symbol indicated in one of the above-mentioned cells, that cell becomes effective and a predetermined profit is provided to a player in accordance with the conditions of the cells that have become effective as a result of repeating the above-mentioned lottery a predetermined number of times, a gaming machine having functions of using the designs of a deck of playing cards as the above-mentioned symbols, allocating symbols in all of the cells of the above-mentioned matrix so that a combination among a plurality of combinations of the above-mentioned designs that are winning combinations in a poker game of cards will be aligned in at least one or more of the plurality of lines of the above-mentioned matrix, playing a game using the matrix having symbols allocated to all of the above-mentioned cells, and, when all cells of a line, made up of cells that indicate a combination of symbols expressing a winning combination in a poker game, become effective, determining, in accordance with the above-mentioned winning combination, the magnitude of disbursement of game media or the multiplication factor of disbursement with respect to the quantity of game media bet by the above-mentioned player.

With the above description, a gaming machine, such as a so-called “bingo gaming machine,” in which cells of a matrix allocated to a player are made effective in accordance with a lottery, has a function to utilize designs of a deck of playing cards as the above-mentioned symbols, allocating symbols to all cells of the above-mentioned matrix so that a combination among a plurality of the above-mentioned designs that are the same as winning combinations in a poker game of cards will be aligned in at least one line of the above-mentioned matrix, playing a game using the matrix having symbols allocated to all cells of the matrix, and, when all cells of a line that indicate a combination of symbols expressing a winning combination in the poker game are made effective, determining, in accordance with the above-mentioned winning combination, the magnitude of disbursement of game media or the multiplication factor of disbursement with respect to the quantity of game media bet by the above-mentioned player. Therefore, fun of a “bingo game” of anticipating whether or not a line of effective cells will be completed and fun of a “poker game” of the proportion of game media returned being determined according to a winning combination formed by a combination of symbols indicated by the effective cells can be combined with each other, thereby enabling a new way of enjoying a game in which the aim is not just to complete any line among the plurality of lines in a “bingo game” but in which the disbursement multiplication factor of game media varies according to what winning combination a line that is completed has.

A “bingo game” has been played in parties and other events, and because of simplicity in rules many people regardless of age or gender enjoy the game. Though in an event, “bingo cards,” made of paper, are usually used in the bingo game, various computer gaming machines simulating the game have also been developed and are installed in many game halls and arcades.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc. It can thus be said that most players select cards randomly.

Thus as in the present invention, by arranging a game to proceed using, as symbols, the combinations of four pattern types and thirteen numbers of a deck of playing cards in place of the numbers in the conventional “bingo game” and arranging so that when a line is completed and the combination of the corresponding symbols form a winning combination of a “poker game,” the disbursement of game media is performed according to the multiplication factor that is in accordance with the type of winning combination, the decision of a player at the point of selecting a card can be made to influence the game result.

For example, such judgments as “selecting a card, in which a combination of symbols, which makes up a ‘royal straight flush,’forms a line, since a larger amount of game media will be disbursed if this line is completed even though the completion of this line may be difficult,” or “selecting a card having a line made up of a winning combination that is small in the disbursement multiplication factor but seems to be more readily completed since the completion of lines made up of winning combinations of large disbursement multiplication factor seems difficult,” etc. can be made.

Furthermore, since by “allocating symbols in all of the cells of the above-mentioned matrix so that a combination among a plurality of the above-mentioned designs that are winning combinations in a poker game of cards will be aligned in at least one or more of the plurality of lines of the above-mentioned matrix,” a matrix with which no winning combination is formed by the alignment of symbols will not be presented to a player, a player can anticipate the receiving of profit no matter which card he or she selects.

According to the present invention, the following is also provided.

In a gaming machine, wherein a symbol is indicated in each of the cells of a matrix, with which the number of cells making up a row is the same as the number of cells making up a column and with which when a symbol selected randomly by a lottery matches a symbol indicated in one of the above-mentioned cells, that cell becomes effective and a predetermined profit is provided to a player in accordance with the conditions of the cells that have become effective as a result of repeating the above-mentioned lottery a predetermined number of times, a gaming machine having functions of using the designs of a set of mahjong tiles as the above-mentioned symbols, allocating symbols in all of the cells of the above-mentioned matrix so that a combination, among a plurality of combinations of the above-mentioned designs that are winning combinations made up of predetermined combinations of symbols, will be aligned in at least one or more of the plurality of lines of the above-mentioned matrix, playing a game using the matrix having symbols allocated to all of the above-mentioned cells, and, when all cells of a line, made up of cells indicating a combination of symbols expressing an above-mentioned predetermined winning combination, become effective, determining, in accordance with the above-mentioned winning combination, the magnitude of disbursement of game media or the multiplication factor of disbursement with respect to the quantity of game media bet by the above-mentioned player.

With the above-described invention, by arranging a gaming machine, such as a so-called “bingo gaming machine,” in which cells of a matrix allocated to a player are made effective in accordance with a lottery, to “have the functions of using the designs of a set of mahjong tiles as the above-mentioned symbols, allocating symbols in all of the cells of the above-mentioned matrix so that a combination, among a plurality of combinations of the above-mentioned designs that are winning combinations made up of predetermined combinations of symbols, will be aligned in at least one or more of the plurality of lines of the above-mentioned matrix, playing a game using the matrix having symbols allocated to all of the above-mentioned cells, and, when all cells of a line, made up of cells indicating a combination of symbols expressing an above-mentioned predetermined winning combination, become effective, determining, in accordance with the above-mentioned winning combination, the magnitude of disbursement of game media or the multiplication factor of disbursement with respect to the quantity of game media bet by the above-mentioned player,” the fun of a “bingo game” of anticipating whether or not a line of effective cells will be completed can be combined with the fun of a “mahjong game” of the proportion of game media returned being determined according to a winning combination formed by a combination of symbols indicated by the effective cells, thereby enabling a new way of enjoying a game in which the aim is not just to complete any line among the plurality of lines in a “bingo game” but in which the disbursement multiplication factor of game media varies according to what winning combination a line that is completed has.

(7) A program used in a gaming machine is performed with a combination-making game. The combination-making game uses a matrix which comprises a row with a row cell number of at least two and a column with a column cell number of at least two, wherein the row cell number equals the column cell number so as to constitute the matrix containing a plurality of cells, each of which has an allocated symbol such that each corresponding cell becomes effective if the allocated symbol to the corresponding cell is selected by a main lottery. The gaming machine is characterized to provide a benefit to a player depending on a pattern of cells being effective after a predetermined number of main lotteries. The program comprising the steps of: creating the matrix having symbols allocated to the respective cells such that at least one combination being composed of a same number of symbols as the row or column cell number matches a predetermined winning combination with a predetermined rank of the combination-making game under a predetermined condition so that the at least one combination is aligned along a line among lines contained in the matrix; storing cells of the matrix being made effective by the predetermined number of main lotteries; and determining amount of disbursement or a multiple number of a bet number of bets made by the player for disbursement depending on the predetermined rank of the winning-stored combination of the combination-making game if the stored cells form the winning-stored combination.

(8) The program according to (7) is characterized in that the combination-making game comprises a poker game and the row cell number of the matrix is five.

(9) The program according to (7) is characterized in that the combination-making game comprises a mahjong game.

According to the present invention, a gaming machine is provided, wherein a symbol is indicated in each of the cells of a matrix comprising five rows and five columns and with which when a symbol selected randomly by a lottery matches a symbol indicated in one of the above-mentioned cells, that cell becomes effective and a predetermined profit is provided to a player in accordance with the conditions of the cells that have become effective as a result of repeating the above-mentioned lottery a predetermined number of times; provided is a program characterized in executing: a symbol allocating step of using the designs of playing cards as the above-mentioned symbols and allocating the symbols in all of the cells of the above-mentioned matrix so that a combination among a plurality of combinations of the above-mentioned designs that are winning combinations in a poker game of cards will be aligned in at least one or more of the plurality of lines of the above-mentioned matrix; and a disbursement value determination step of playing a game using the matrix having symbols allocated to all of the above-mentioned cells by the above-mentioned symbol allocating step and, when all cells of a line, made up of cells that indicate a combination of symbols expressing a winning combination in a poker game, become effective, determining, in accordance with the above-mentioned winning combination, the magnitude of disbursement of game media or the multiplication factor of disbursement with respect to the quantity of game media bet by the above-mentioned player.

With the above-described invention, by arranging for a gaming machine, such as a so-called “bingo gaming machine,” in which cells of a matrix allocated to a player are made effective in accordance with a lottery, a program “executing a symbol allocating step of using the designs of playing cards as the above-mentioned symbols and allocating the symbols in all of the cells of the above-mentioned matrix so that a combination among a plurality of combinations of the above-mentioned designs that are winning combinations in a poker game of cards will be aligned in at least one or more of the plurality of lines of the above-mentioned matrix; and a disbursement value determination step of playing a game using the matrix having symbols allocated to all of the above-mentioned cells by the above-mentioned symbol allocating step and, when all cells of a line, made up of cells that indicate a combination of symbols expressing a winning combination in a poker game, become effective, determining, in accordance with the above-mentioned winning combination, the magnitude of disbursement of game media or the multiplication factor of disbursement with respect to the quantity of game media bet by the above-mentioned player,” the fun of a “bingo game” of anticipating whether or not a line of effective cells will be completed can be combined with the fun of a “poker game” of the proportion of game media returned being determined according to a winning combination formed by a combination of symbols indicated by the effective cells, thereby enabling a new way of enjoying a game in which the aim is not just to complete any line among the plurality of lines in a “bingo game” but in which the disbursement multiplication factor of game media varies according to what winning combination a line that is completed has.

A “bingo game” has been played in parties and other events, and because of simplicity in rules many people regardless of age or gender enjoy the game. Though in an event, “bingo cards,” made of paper, are usually used in the bingo game, various computer gaming machines simulating the game have also been developed and are installed in many game halls and arcades.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc. It can thus be said that most players select cards randomly.

Thus as in the present invention, by arranging a game to proceed using, as symbols, the combinations of four pattern types and thirteen numbers of a deck of playing cards in place of the numbers in the conventional “bingo game” and arranging so that when a line is completed and the combination of the corresponding symbols form a winning combination of a “poker game,” the disbursement of game media is performed according to the multiplication factor that is in accordance with the type of winning combination, the decision of a player at the point of selecting a card can be made to influence the game result.

For example, such judgments as “selecting a card, in which a combination of symbols, which makes up a ‘royal straight flush,’ forms a line, since a larger amount of game media will be disbursed if this line is completed even though the completion of this line may be difficult,” or “selecting a card having a line made up of a winning combination that is small in the disbursement multiplication factor but seems to be more readily completed since the completion of lines made up of winning combinations of large disbursement multiplication factor seems difficult,” etc. can be made.

Furthermore, since by “allocating symbols to all of the cells of the above-mentioned matrix so that a combination among a plurality of the above-mentioned designs that are winning combinations in a poker game of cards will be aligned in at least one or more of the plurality of lines of the above-mentioned matrix,” a matrix with which no winning combination is formed by the alignment of symbols will not be presented to a player, a player can anticipate the receiving of profit no matter which card he or she selects.

According to the present invention, the following is also provided.

In a gaming machine, wherein a symbol is indicated in each of the cells of a matrix, with which the number of cells making up a row is the same as the number of cells making up a column and with which when a symbol selected randomly by a lottery matches a symbol indicated in one of the above-mentioned cells, that cell becomes effective and a predetermined profit is provided to a player in accordance with the conditions of the cells that have become effective as a result of repeating the above-mentioned lottery a predetermined number of times; a program characterized in executing a symbol allocating step of using the designs of mahjong tiles as the above-mentioned symbols and allocating symbols to all of the cells of the above-mentioned matrix so that a combination, among a plurality of combinations of the above-mentioned designs that are winning combinations made up of predetermined combinations of symbols, will be aligned in at least one or more of the plurality of lines of the above-mentioned matrix; and a disbursement value determination step, of playing a game using the matrix having symbols allocated to all of the above-mentioned cells by the above-mentioned symbol allocating step and, when all cells of a line, made up of cells that indicate a combination of symbols expressing an above-mentioned predetermined winning combination, become effective, determining, in accordance with the above-mentioned winning combination, the magnitude of disbursement of game media or the multiplication factor of disbursement with respect to the quantity of game media bet by the above-mentioned player.

With the above-described invention, by arranging for a gaming machine, such as a so-called “bingo gaming machine,” in which cells of a matrix assigned to a player are made effective in accordance with a lottery, a program “executing a symbol allocating step of using the designs mahjong tiles as the above-mentioned symbols and allocating symbols to all of the cells of the above-mentioned matrix so that a combination, among a plurality of combinations of the above-mentioned designs that are winning combinations made up of predetermined combinations of symbols, will be aligned in at least one or more of the plurality of lines of the above-mentioned matrix; and a disbursement value determination step, of playing a game using the matrix having symbols allocated to all of the above-mentioned cells by the above-mentioned symbol allocating step and, when all cells of a line, made up of cells that indicate a combination of symbols expressing an above-mentioned predetermined winning combination, become effective, determining, in accordance with the above-mentioned winning combination, the magnitude of disbursement of game media or the multiplication factor of disburs ment with respect to the quantity of game media bet by the above-mentioned player,” the fun of a “bingo game” of anticipating whether or not a line of effective cells will be completed can be combined with the fun of a “mahjong game” of the proportion of game media returned being determined according to a winning combination formed by a combination of symbols indicated by the effective cells, thereby enabling a new way of enjoying a game in which the aim is not just to complete any line among the plurality of lines in a “bingo game” but in which the disbursement multiplication factor of game media varies according to what winning combination a line that is completed has.

(10) A server is characterized to be connectable via a communication line to gaming machines, with each of which a combination-making game is performed. The combination-making game utilizes a matrix which comprises a row with a row cell number of at least two and a column with a column cell number of at least two, wherein the row cell number equals the column cell number so as to constitute the matrix containing a plurality of cells, each of which has an allocated symbol such that each corresponding cell becomes effective if the allocated symbol to the corresponding cell is selected by a main lottery. Each gaming machine is characterized to provide a benefit to a player depending on a pattern of cells being effective after a predetermined number of main lotteries. The server comprises; a symbol allocating means for allocating symbols to the respective cells such that at least one combination being composed of a same number of symbols as the row or column cell number matches a predetermined winning combination with a predetermined rank of the combination-making game under a predetermined condition so that the at least one combination is aligned along a line among lines contained in the matrix; and a disbursement value determination means for determining amount of disbursement or a multiple number of a bet number of bets made by the player for disbursement depending on the predetermined rank of the combination of the combination-making game if all cells with allocated symbols along the first line so as to make the winning combination become effective after the predetermined number of lotteries are made with the matrix having symbols allocated to the respective cells thereof,

(11) A gaming machine being connected to the server according to (10) via said communication line comprises: a communicating means for communicating via said communication line with the server and displaying means for displaying progress of the game to the player.

This invention provides a server connectable via a communication line to gaming machines, with each of which a symbol is indicated in each of the cells of a matrix comprising five rows and five columns and with which when a symbol selected randomly by a lottery matches a symbol indicated in one of the above-mentioned cells, that cell becomes effective and a predetermined profit is provided to a player in accordance with the conditions of the cells that have become effective as a result of repeating the above-mentioned lottery a predetermined number of times; a server comprising a symbol allocating means, which uses the designs of a deck of playing cards as the above-mentioned symbols and allocates symbols to all of the cells of the above-mentioned matrix so that a combination among a plurality of combinations of the above-mentioned designs that are winning combinations in a poker game of cards will be aligned in at least one or more of the plurality of lines of the above-mentioned matrix; and a disbursement value determination means, which carries out a game using the matrix having symbols allocated to all of the above-mentioned cells by the above-mentioned symbol allocating means and, when all cells of a line, made up of cells that indicate a combination of symbols expressing a winning combination in a poker game, become effective, determines, in accordance with the above-mentioned winning combination, the magnitude of disbursement of game media or the multiplication factor of disbursement with respect to the quantity of game media bet by the above-mentioned player.

With the above-described invention, by arranging a server, which controls gaming machines, such as a so-called “bingo gaming machine,” wherein cells of a matrix allocated to a player are made effective in accordance with a lottery, so as to “have a symbol allocating means, which uses the designs of a deck of playing cards as the above-mentioned symbols and allocates symbols to all of the cells of the above-mentioned matrix so that a combination among a plurality of the above-mentioned designs that are winning combinations in a poker game of cards will be aligned in at least one or more of the plurality of lines of the above-mentioned matrix; and a disbursement value determination means, which carries out a game using the matrix having symbols allocated to all of the above-mentioned cells by the above-mentioned symbol allocating means and, when all cells of a line, made up of cells that indicate a combination of symbols expressing a winning combination in a poker game, become effective, determines, in accordance with the above-mentioned winning combination, the magnitude of disbursement of game media or the multiplication factor of disbursement with respect to the quantity of game media bet by the above-mentioned player,” the fun of a “bingo game” of anticipating whether or not a line of effective cells will be completed can be combined with the fun of a “poker game” of the proportion of game media returned being determined according to a winning combination formed by a combination of symbols indicated by the effective cells, thereby enabling a new way of enjoying a game in which the aim is not just to complete any line among the plurality of lines in a “bingo game” but in which the disbursement multiplication factor of game media varies according to what winning combination a line that is completed has.

A “bingo game” has been played in parties and other events, and because of simplicity in rules many people regardless of age or gender enjoy the game. Though in an event, “bingo cards,” made of paper, are usually used in the bingo game, various computer gaming machines simulating the game have also been developed and are installed in many game halls and arcades.

However, since the “bingo game” is simple in rules, its results are affected only by luck and it can be said that there is no intervention whatsoever of a player's judgment. Though a player has the right of selection in selecting a “bingo card,” if the numbers are just aligned randomly, the standard for this selection will be a trivial one, such as “because I like this number” or “I feel that I can win with the second from the right,” etc. It can thus be said that most players select cards randomly.

Thus as in the present invention, by arranging a game to proceed using, as symbols, the combinations of four pattern types and thirteen numbers of a deck of playing cards in place of the numbers in the conventional “bingo game” and arranging so that when a line is completed and the combination of the corresponding symbols form a winning combination of a “poker game,” the disbursement of game media is performed according to the multiplication factor that is in accordance with the type of winning combination, the decision of a player at the point of selecting a card can be made to influence the game result.

For example, such judgments as “selecting a card, in which a combination of symbols, which makes up a ‘royal straight flush,’ forms a line, since a larger amount of game media will be disbursed if this line is completed even though the completion of this line may be difficult,” or “selecting a card having a line made up of a winning combination that is small in the disbursement multiplication factor but seems to be more readily completed since the completion of lines made up of winning combinations of large disbursement multiplication factor seems difficult,” etc. can be made.

Furthermore, since by “allocating symbols in all of the cells of the above-mentioned matrix so that a combination among a plurality of the above-mentioned designs that are winning combinations made up of predetermined combinations of symbols will be aligned in at least one or more of the plurality of lines of the above-mentioned matrix,” a player is necessarily provided with the possibility of receiving game media disbursement of a high multiplication factor, it is possible to make a player anticipate an advantageous result.

According to the present invention, the following is also provided.

In a server connectable via a communication line to gaming machines, with each of which a symbol is indicated in each of the cells of a matrix, with which the number of cells making up a row is the same as the number of cells making up a column and with which when a symbol selected randomly by a lottery matches a symbol indicated in one of the above-mentioned cells, that cell becomes effective and a predetermined profit is provided to a player in accordance with the conditions of the cells that have become effective as a result of repeating the above-mentioned lottery a predetermined number of times; a server comprising a symbol allocating means, which uses the designs of mahjong tiles as the above-mentioned symbols and allocates symbols to all of the cells of the above-mentioned matrix so that a combination, among a plurality of combinations of the above-mentioned designs that are winning combinations made up of predetermined combinations of symbols, will be aligned in at least one or more of the plurality of lines of the above-mentioned matrix; and a disbursement value determination means, which carries out a game using the matrix having symbols allocated to all of the above-mentioned cells by the above-mentioned symbol allocating means and, when all cells of a line, made up of cells that indicate a combination of symbols expressing an above-mentioned predetermined winning combination, become effective, determines, in accordance with the above-mentioned winning combination, the magnitude of disbursement of game media or the multiplication factor of disbursement with respect to the quantity of game media bet by the above-mentioned player.

With the above-described invention, by arranging a server, which controls a gaming machine, such as a so-called “bingo gaming machine,” wherein cells of a matrix assigned to a player are made effective in accordance with a lottery, so as to “have a symbol allocating means, which uses the designs of a set of mahjong tiles as the above-mentioned symbols and allocates symbols to all of the cells of the above-mentioned matrix so that a combination, among a plurality of combinations of the above-mentioned designs that are winning combinations made up of predetermined combinations of symbols, will be aligned in at least one or more of the plurality of lines of the above-mentioned matrix; and a disbursement value determination means, which carries out a game using the matrix having symbols allocated to all of the above-mentioned cells by the above-mentioned symbol allocating means and, when all cells of a line, made up of cells that indicate a combination of symbols expressing an above-mentioned predetermined winning combination, become effective, determines, in accordance with the above-mentioned winning combination, the magnitude of disbursement of game media or the multiplication factor of disbursement with respect to the quantity of game media bet by the above-mentioned player,” the fun of a “bingo game” of anticipating whether or not a line of effective cells will be completed can be combined with the fun of a “mahjong game” of the proportion of game media returned being determined according to a winning combination formed by a combination of symbols indicated by the effective cells, thereby enabling a new way of enjoying a game in which the aim is not just to complete any line among the plurality of lines in a “bingo game” but in which the disbursement multiplication factor of game media varies according to what winning combination a line that is completed has.

[Definition of Terms]

With the present invention, “cell number” refers to the number of cells. By aligning such cells along a single line, a single row (or column) can be arranged. That is, the cell is the unit by which the number of rows (or columns) is counted. For example, a matrix made up of rows of a cell number of 5 and columns of a cell number of 5 is a so-called 5×5 matrix (or a matrix of five rows and five columns). Also, a “line” refers to a set of cells that are aligned along a straight line in the row direction, column direction, or diagonal direction of a matrix. The same number of cells as the cell number of a row or column is thus contained in a single line. Once a matrix is determined, the total number of lines is determined. However, the number of applicable lines in a matrix that are involved in a game in accordance with predetermined conditions of a gaming machine can be determined arbitrarily.

The “completion” of a line refers to the state where all symbols indicated in cells contained in the line have been made effective by lottery results.

Furthermore, a “winning combination” refers to a state where a certain combination of symbols is a specific combination that satisfies conditions that have been determined in advance. Examples include the “one pair,” “full house,” “royal straight flush,” etc. in a poker game.

Further features of the invention, its nature and various advantages will be more apparent from the accompanying drawing and the following detailed description of the invention.

### BRIEF DESCRIPTION OF THE DRAWINGS

FIG. 1 is a perspective view showing the general appearance of a gaming machine according to this invention.

FIG. 2 is an enlarged front view of the vicinity of a display device of this invention's gaming machine.

FIG. 3 is a block diagram showing the main control circuit of a gaming machine that is an embodiment of this invention.

FIG. 4 is a schematic view illustrating a method of recording of lottery results of this invention's gaming machine.

FIG. 5 shows a data sheet that shows the correspondence between symbol codes and symbols used in this invention's gaming machine.

FIG. 6 is a block diagram showing a display control device of the gaming machine that is this invention's embodiment.

FIG. 7 is a schematic view showing a screen display of the gaming machine according to this invention.

FIG. 8 is a schematic view showing a screen display of the gaming machine according to this invention.

FIG. 9 is a schematic view showing a screen display of the gaming machine according to this invention.

FIG. 10 is a schematic view showing a screen display of the gaming machine according to this invention.

FIG. 11 is a schematic view showing a screen display of the gaming machine according to this invention.

FIG. 12 is a schematic view showing a screen display of the gaming machine according to this invention.

FIG. 13 is a flowchart of a control process that maybe executed by the gaming machine according to this invention.

FIG. 14 is a flowchart of a control process example that may be executed by the gaming machine according to this invention.

FIG. 15 is a flowchart of a control process example that may be executed by the gaming machine according to this invention.

FIG. 16 is a flowchart of a control process example that may be executed by the gaming machine according to this invention.

FIG. 17 is a flowchart of a control process example that may be executed by the gaming machine according to this invention.

FIG. 18 is a diagram illustrating an outline of an arrangement wherein a server and gaming machines are connected via a network.

### DETAILED DESCRIPTION OF THE INVENTION

An embodiment of this invention shall now be described based on the drawings.

[Arrangement of a Gaming Machine]

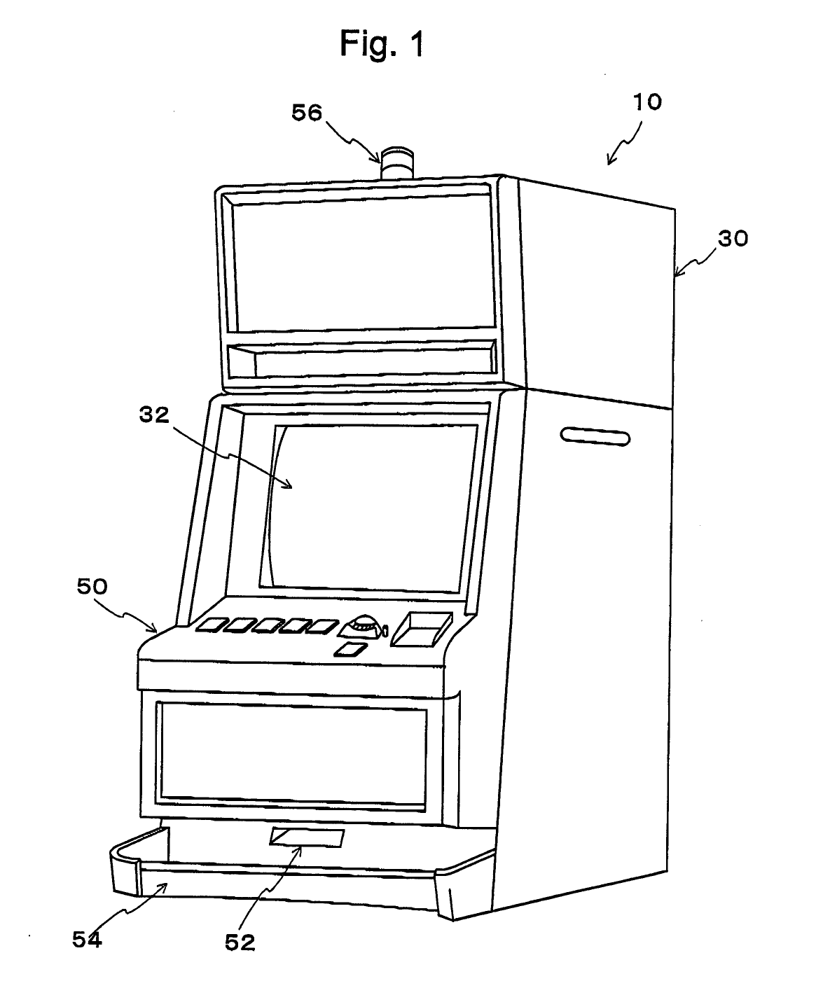

An example of a gaming machine 10, which is an embodiment of this invention, is shown in FIG. 1.

Gaming machine 10 is arranged from a casing 30, the central front part of casing 30 has an incline that is inclined somewhat to the rear with respect to the vertical direction, and a display device 32 is disposed on this surface. Display device 32 displays game information when a game is executed and a game progresses on this display device.

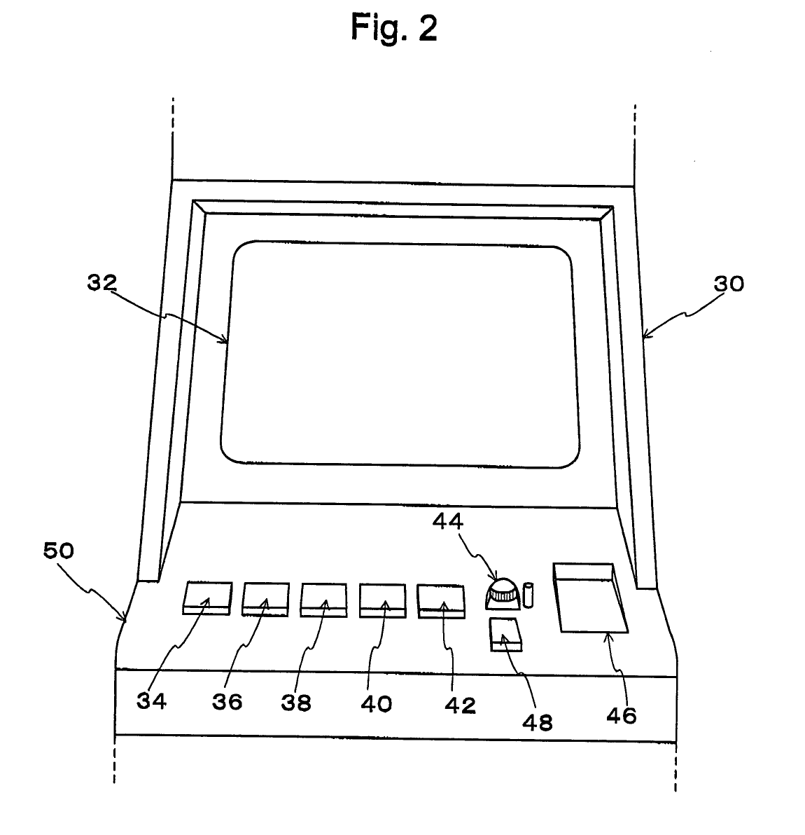

A substantially horizontal base part 50 is disposed below display device 32 and various switches, etc. are disposed on the upper part of this base part. FIG. 2 shows an enlarged view of the vicinity of base part 50.

Five switches are aligned from the left side to the central part of base part 50. These are, from the left side, selection switches 34 and 36, determination switch 38, cancellation switch 40, and bet switch 42. These switches are used to instruct a selection or determination, etc. in the process of executing a game.

A coin slot 44 and a bill slot 46 are disposed at the right side of the upper face of base 50. The execution of a game is enabled by the loading of coins or bills in these slots.

Furthermore, a disbursement switch 48 is disposed near coin slot 44, and by pressing this switch, loaded coins are disbursed from coin disbursement slot 52 at the lower part of the front face of casing 30 and the disbursed coins are accumulated in coin retainer 54.

[Arrangement of the Control Device of the Gaming Machine]

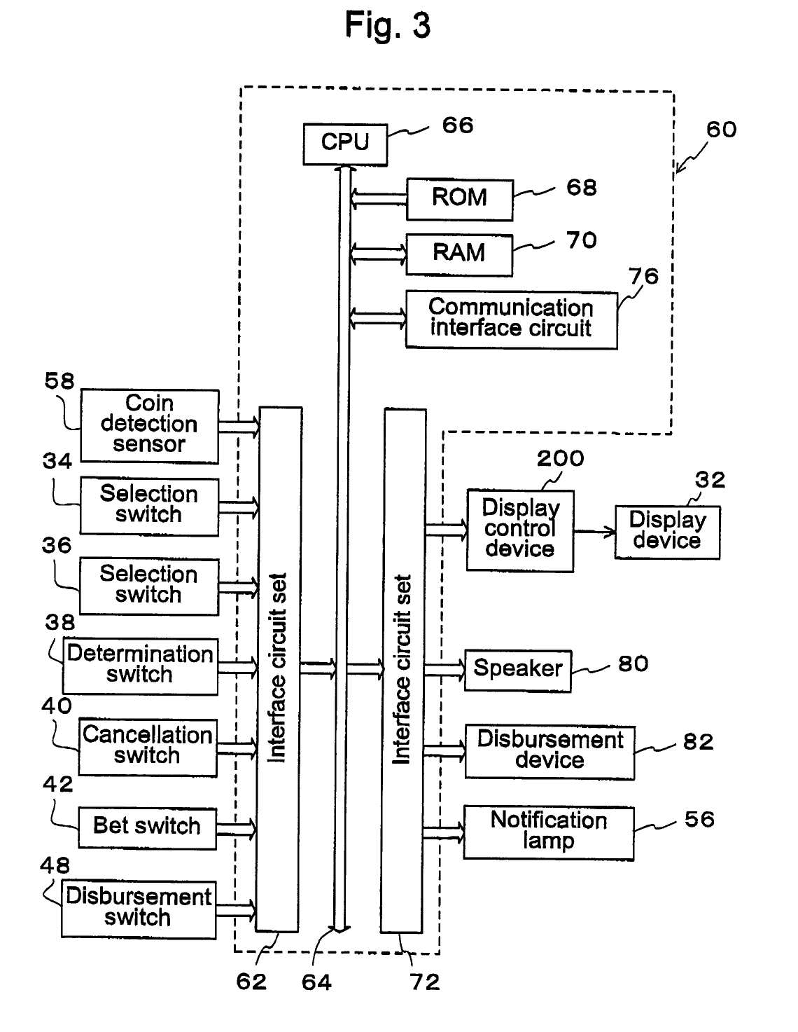

FIG. 3 shows a block diagram of the arrangement of a control unit of the above-mentioned gaming machine 10.

The above-mentioned selection switches 34 and 36, determination switch 38, cancellation switch 40, and bet switch 42 are connected to an interface circuit set 62 of a main control circuit 60, and interface circuit set 62 is connected to input/output bus 64. When a switch is pressed, a corresponding predetermined signal is generated and supplied to input/output bus 64. Input/output bus 64 is arranged for input and output of data signals or address signals into and from a CPU 66.

A coin and bill detection sensor 58 is also connected to the above-mentioned interface circuit set 62, and when coins are loaded into the above-mentioned coin slot 44 or bills are loaded into bill slot 46, information concerning the type and number of the loaded coins or bills is converted into a signal and this signal is supplied to interface circuit set 62.

Disbursement switch 48 is also connected to the above-mentioned interface circuit set 62, and when a player presses disbursement switch 48, a predetermined signal is supplied to input/output bus 64, and based on this signal, loaded coins are disbursed to coin disbursement slot 52 by a disbursement device 82 to be described below.

A ROM (read only memory) 68 and a RAM (random access memory) 70 are also connected to the above-mentioned input/output bus 64. ROM 68 stores a control program for controlling the flow of the entire system of the gaming machine. ROM 68 also stores the initial data for executing the control program, a part of a program for performing display control of display device 32, etc. RAM 70 stores the values of flags and variables to be used in the above-mentioned programs and the game program to be described below.

The control program of the present embodiment includes that which “uses the designs of playing cards as the above-mentioned symbols and allocates the symbols to all of the cells of the above-mentioned matrix so that a combination among a plurality of combinations of the above-mentioned designs that are winning combinations in a poker game of cards will be aligned in at least one or more of the plurality of lines of the above-mentioned matrix,” that which, “carries out a game using the matrix having symbols allocated to all of the above-mentioned cells by the above-mentioned symbol allocating step and, when all cells of a line, made up of cells that indicate a combination of symbols expressing a winning combination in a poker game, become effective, determines, in accordance with the above-mentioned winning combination, the magnitude of disbursement of game media or the multiplication factor of disbursement with respect to the quantity of game media bet by the above-mentioned player,” that which “uses the designs of mahjong tiles as the above-mentioned symbols and allocates symbols to all of the cells of the above-mentioned matrix so that a combination, among a plurality of combinations of the above-mentioned designs that are winning combinations made up of predetermined combinations of symbols, will be aligned in at least one or more of the plurality of lines of the above-mentioned matrix, and that which “carries out a game using the matrix having symbols allocated to all of the above-mentioned cells by the above-mentioned symbol allocating step and, when all cells of a line, made up of cells that indicate a combination of symbols expressing an above-mentioned predetermined winning combination, become effective, determines, in accordance with the above-mentioned winning combination, the magnitude of disbursement of game media or the multiplication factor of disbursement with respect to the quantity of game media bet by the above-mentioned player.”

An interface circuit set 72 is also connected to input/output bus 64. A speaker 81, a notification lamp 56, and disbursement device 82 are connected to interface circuit set 72, and interface circuit set 72 supplies drive signals and drive power for controlling each of these devices in accordance with the results of computations performed by CPU 66.

Notification lamp 56 becomes lit or blinks when an anomaly of gaming machine 10 is detected, when a player calls a game hall worker, etc. and notifies such conditions to a game hall worker.

Furthermore, a communication interface circuit 76 is also connected to input/output bus 64, and communication interface circuit 76 is for communication with a server, etc. via a public telephone line, LAN, or other communication line.

Yet furthermore, a display control device 200 is also connected to interface circuit set 72, and based on a screen display instruction issued from main control circuit 60, display control device 200 generates a drive signal for driving display device 32 connected to display control device 200.

[Internal Lottery Method]

An internal lottery is performed in the gaming machine process to be described b low, and with this internal lottery, a random number is generated and internal lottery data is obtained based on the random number obtained.

With regard to the method of generating a random number in the internal lottery, an external random number generation system or a software random number generation system is mainly used. With an external random number generation system, a random number is generated by a random number generating part, such as a binary counter IC, etc., that is disposed on a circuit board separate from the CPU. With a software random number generation system, the CPU itself forms a counter, renews the numerical value of the counter in accordance with a program stored in the ROM, and uses this numerical value as a random number.

With the gaming machine of the present embodiment, a random number is generated by a software random number generation system. However, the method of generating a random number in the gaming machine by this invention is not limited to that by a software random number generation system and an external random number generation system or other arrangement by which a single numerical value can be extracted from a plurality of numerical values without making a player sense regularity may be used instead.

An arrangement wherein a random number is not generated and a symbol is directly selected by lottery is also possible. Furthermore, the lottery is not limited to that by an electrical process inside a control device, and a symbol may be selected by a physical lottery method instead. For example,balls marked with the symbols used in the corresponding game may be prepared, placed in a container, taken out one by one, and the symbol marked on the ball that has been taken out may be used as the lottery result.

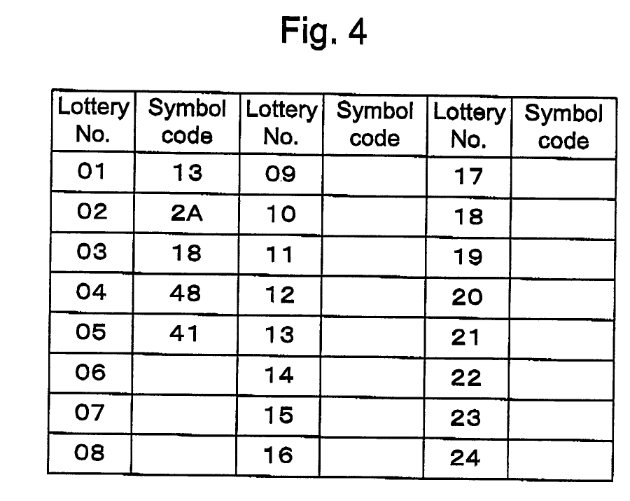

The random number that is obtained by the above-mentioned lottery is converted into a symbol code using a conversion table stored in ROM 68 and stored in the order of selection by lottery in a data map, such as that shown in FIG. 4. The data map shown in FIG. 4 is an example illustrating the state where lottery has been performed five times.

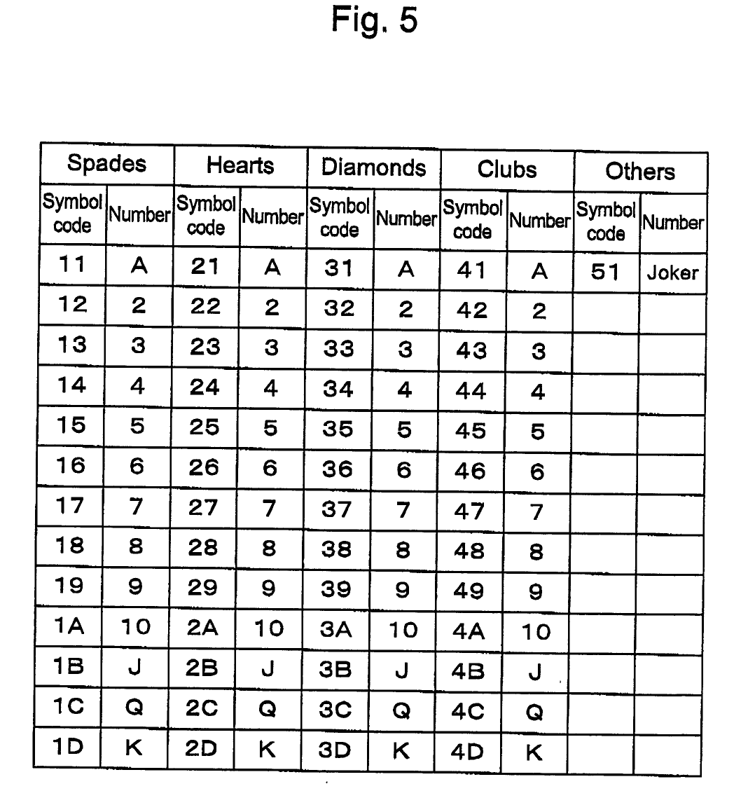

The symbol codes here are codes for identifying each of the playing card designs that are the symbols used in the game by this invention, and are classified as shown in FIG. 5. CPU 66 recognizes the mark of a symbol from the upper digit of the symbol code and the numeral of a symbol from the lower digit of the symbol code and then judges whether or not the combinations along the respective lines form winning combinations.

Similar symbol codes are also used in a case where the designs of mahjong tiles are used as the symbols.

[Arrangement of the Display Control Device of the Gaming Machine]

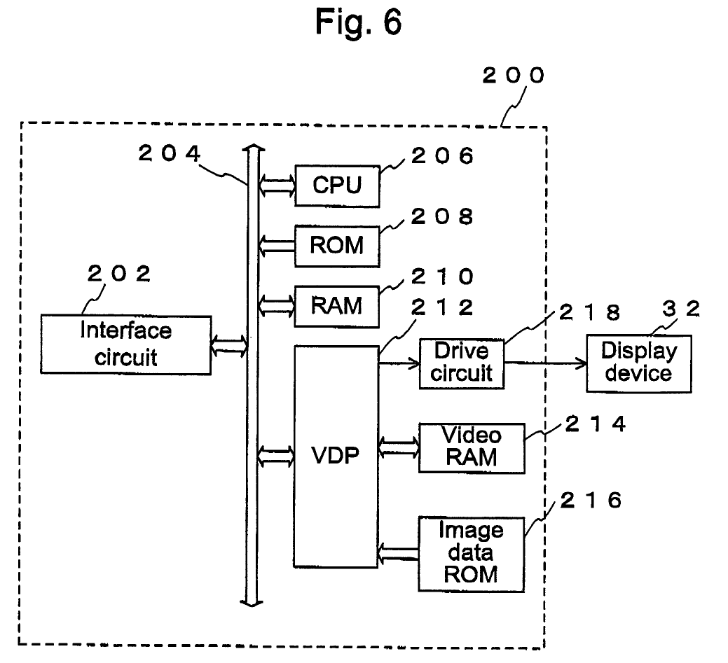

FIG. 6 shows a block diagram of the circuit of the above-mentioned display control device 200.

An interface circuit 202 is connected to an input/output bus 204, and an image display instruction issued from the above-mentioned main control circuit 60 is supplied via interface circuit 202 to input/output bus 204. Input/output bus 204 is arranged for input and output of data signals or address signals to and from CPU 206.

A ROM 208 and a RAM 210 are also connected to the above-mentioned input/output bus 204. ROM 208 stores a display control program for generating drive signals to be supplied to display device 32 based on image display instructions generated from main control circuit 60. Meanwhile, RAM 210 stores the values of the flags and variables used in the above-mentioned program.

Furthermore, an image data processor (referred to hereinafter as “VDP”) 212 is also connected to input/output bus 204. This VDP 212 includes a so-called sprite circuit, a screen circuit, and a palette circuit, and is a processing device that can perform various processes for making display device 32 display images.

To the above-mentioned VDP 212 are connected a video RAM 214, for storing image data in accordance with image display instructions generated from main control circuit 60, and an image data ROM 216, for storing background image data, design image data, and other image data.

By reading and executing the display control program stored in ROM 208, the above-mentioned CPU 206 stores, in video RAM 214, the image data to be displayed on display device 32 in accordance with image display instructions generated from main control circuit 60. The image display instructions generated from main control circuit 60 include a background display instruction, design display instruction, character figure display instruction, and other display instructions.

As mentioned above, image data ROM 216 stores the data of design images, which are identification information images, character figure image data of animated objects and other character figures displayed for an effect screen, background image data, which make up the backgrounds of display devices 32, etc., and other image data.

The respective above-mentioned image data are synthesized at VDP 212, the synthesized image data are thereafter sent to drive circuit 218, and drive circuit 218 drives display device 32 to make images be displayed on image device 32.

[Display Examples of Images]

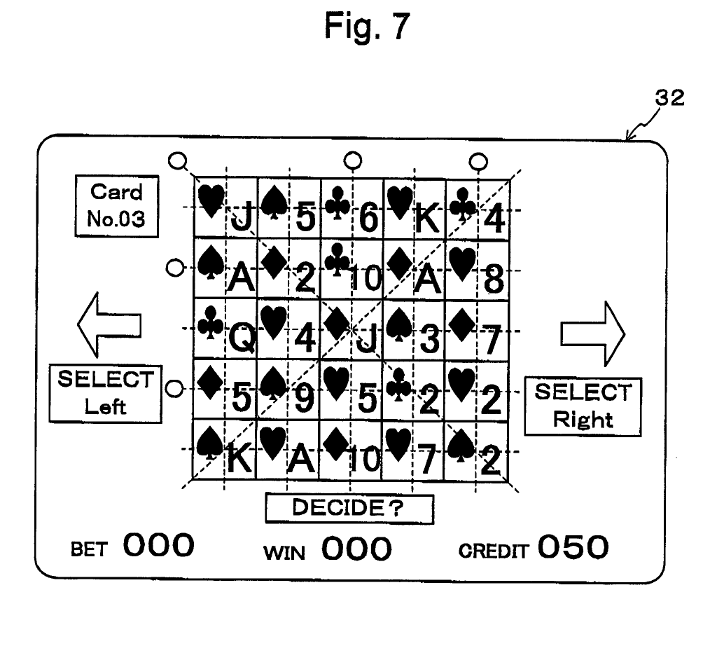

As mentioned above, by recording image data in video RAM 214, images are displayed on display device 32 and a game is thereby made to proceed. Display examples of images that are displayed in this game are shown in FIG. 7 through FIG. 12.

FIG. 7 shows an example of a screen display for making a player select a matrix card at the start of a game. A single matrix card is displayed at the central part of the screen and arrows are displayed to its left and right. These arrows indicate that other matrix cards that the player can select have been prepared, and when a player presses selection switch 34 or 36 in accordance with either arrow, another matrix card is displayed in place of the presently displayed matrix card. A player views this card and selects whether to play the game with this card or to play the game using another card. Since it is difficult for a player to quickly recognize in which of the plurality of lines winning combinations are completed, the recognition is facilitated by indicating circles close to the broken lines that express the respective lines in the case of lines in which winning combinations are formed, as shown in FIG. 7.

Furthermore, at the lower part of the screen, the number of coins that are bet in the presently played game, the number of coins to be disbursed to the player as a result of a game, and the total number of coins loaded in gaming machine 10 are displayed in that order starting from the left side. With the example of FIG. 7, since the player has not yet bet any coins in the present game, the number of coins bet in the presently played game is indicated as 0. The number of coins to be disbursed as a result of the game is also displayed as being 0. And here, as an example of a case where the player has loaded 50 coins, the total number of coins loaded in this gaming machine 10 is indicated as being 50.

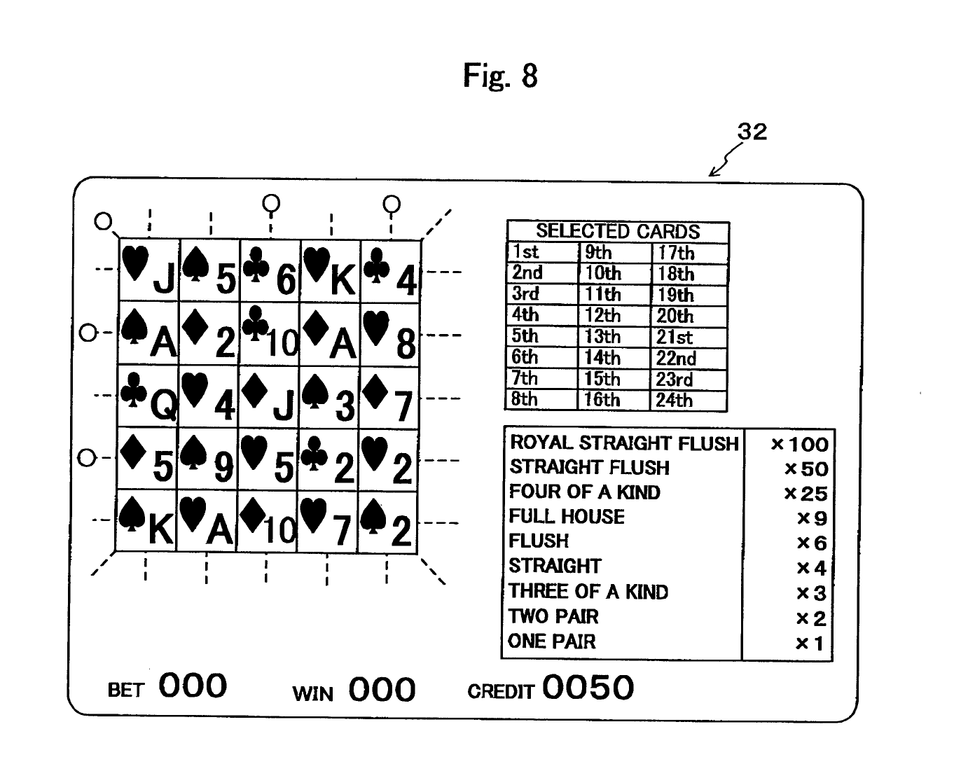

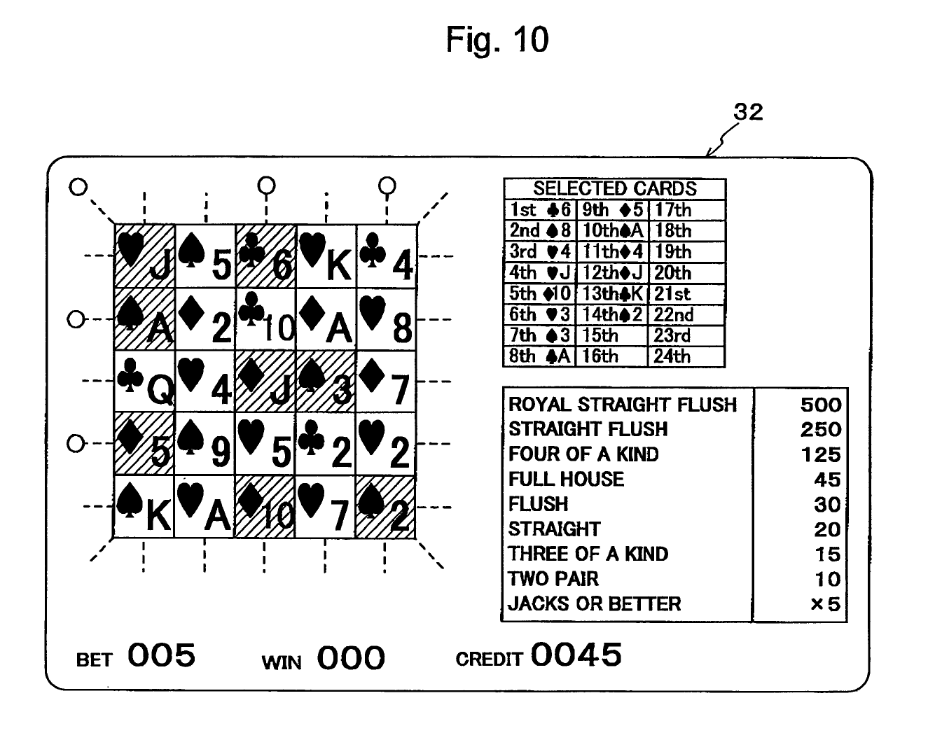

FIG. 8 shows an example of a screen display at a point at which the selection of the matrix card has ended and the player has entered the stage of operation of betting coins. The matrix card that has been selected by the player is shown at the left side of the screen and at the upper right part of the screen, a list, which indicates, in the order of the lottery, the card designs that have been selected after the start of the game, is displayed (see FIG. 10). Furthermore, at the lower right part of the screen is displayed a multiplication factor table, which indicates the disbursement multiplication factors with respect to the number of coins bet that are used when lines of various winning combinations have been completed and coins are to be disbursed. The player determines the number of bet coins upon referencing the matrix card and the multiplication factor table.

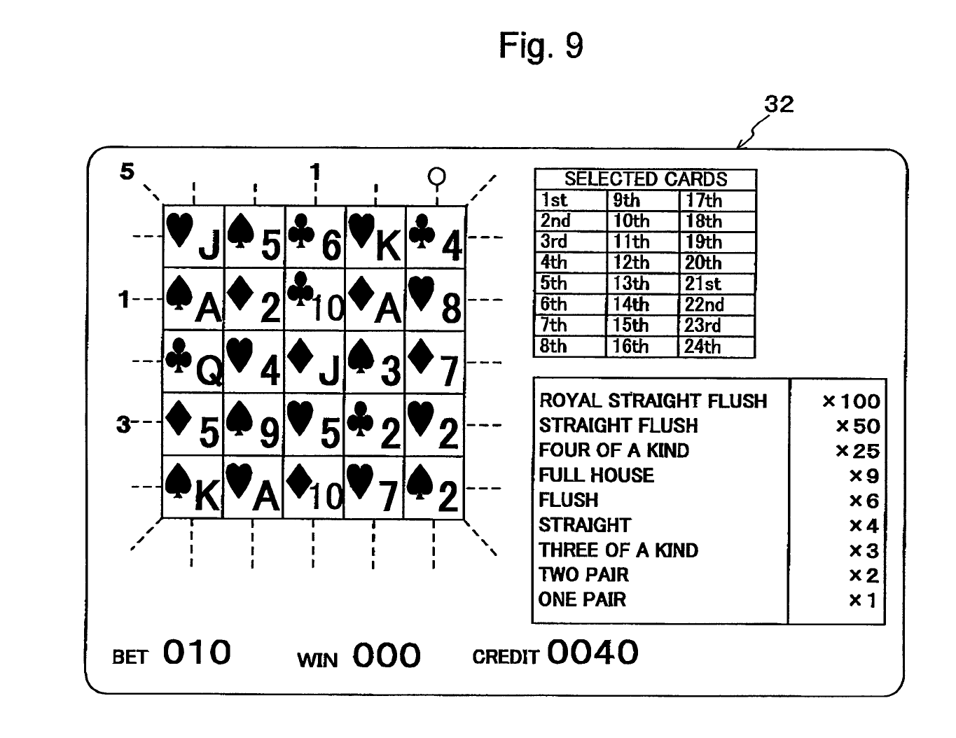

FIG. 9 shows a screen display example for a game of a method, with which a player does not bet coins for the entirety of a matrix card but bets coins according to each line, and illustrates the screen at a point in time at which coins have been bet according to line. With a line on which coins are bet, the number of bet coins is displayed in place of the circle indicating the forming of a winning combination, and the total number of coins bet is shown at the lower left part of the screen.

FIG. 10 shows a screen display example in the middle of the progress of the game. With this game, the player has bet five coins and this number is displayed at the lower left part of the screen. Also, fourteen cards have already been selected and the designs of the respective cards are displayed in the order of selection in the list at the upper right part of the screen. Of the designs displayed in the matrix card, the designs that match the designs of the cards that have been selected are indicated by changing the color of the cells in which the designs are displayed, thereby making the player recognize that these cells have been made effective.

In the multiplication factor table displayed at the lower left part of the screen, the numbers of coins that may actually be disbursed are determined and displayed by multiplying the numerals of the multiplication factors shown in FIG. 8 by the actually bet number of coins.

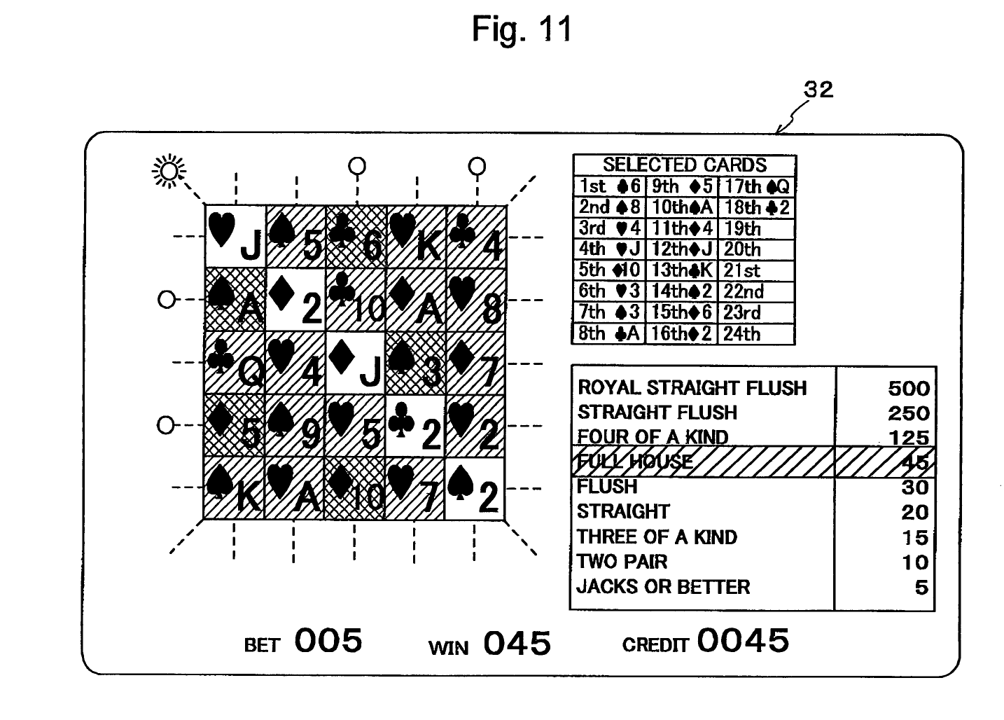

FIG. 11 shows a screen display example of a case where all cells along the diagonal line that extends from the upper left cell to the lower right cell of the matrix card have become effective and the “full house” winning combination has been formed. In this case, by making the colors of the cells along this line different from those of other cells, the cells of the line are made more readily identifiable and the player is thereby made to recognize that this line has been completed. The “full house” part of the multiplication factor table at the lower right part of the screen is also differed in color to notify the winning combination that has been completed and the number of coins to be disbursed to the player. The number of coins to be disbursed in this game is also displayed at the lower central part of the screen. This number is thereafter added to the remaining number of coins loaded that is indicated to the right.

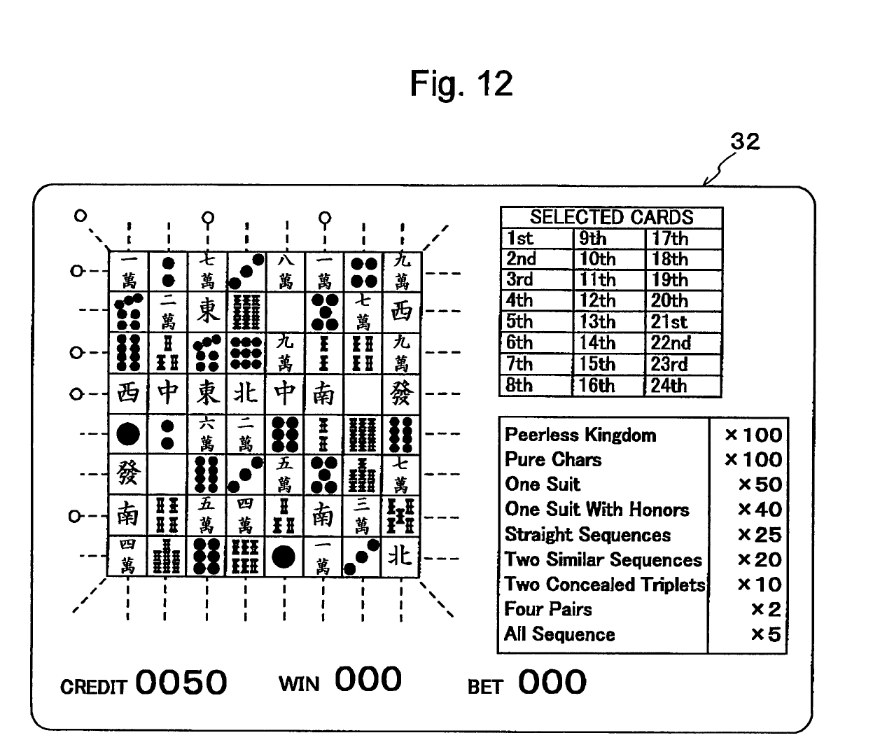

FIG. 12 shows a screen display example of a case where mahjong tile designs are used as symbols and a matrix card of eight rows x eight columns is used. Though due to the differences in the designs of the symbols the winning combinations used in this game differ from the winning combinations of poker, the method of display is the same as that of the poker game in other aspects. Also, since there are only eight cells along a single line, the winning combinations of normal mahjong cannot be applied and the game is played using winning combinations that correspond to such winning combinations.

[Operation of the Gaming Machine]

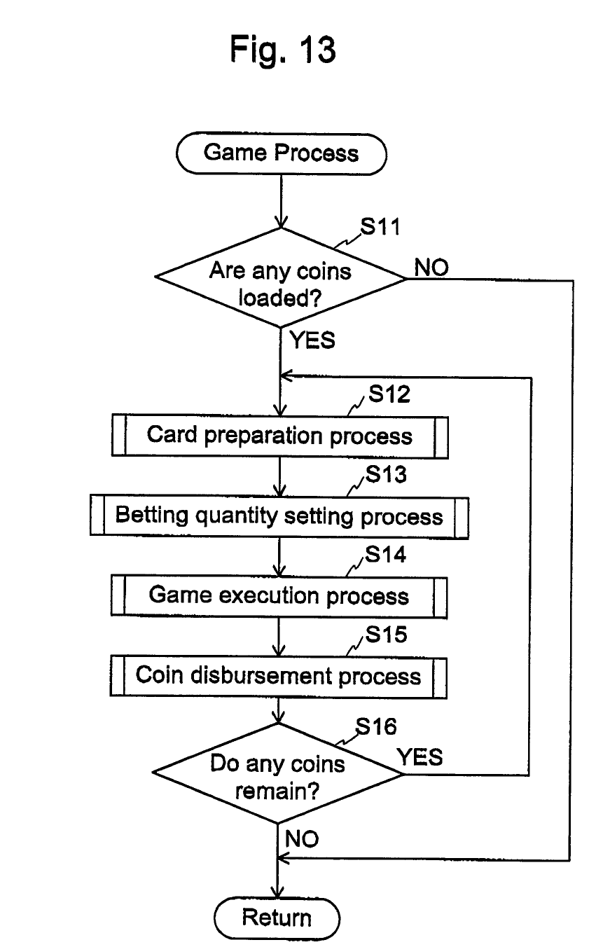

Subroutines for controlling gaming machine 10, which are executed by the above-described main control circuit 60, are shown in FIG. 13 through FIG. 17. The subroutine shown in FIG. 13 is called and executed at a predetermined timing from a main program of gaming machine 10 that is executed in advance.

In the following, it shall be deemed that gaming machine 10 has been started in advance, the variables used in the above-described CPU 66 are initialized, and steady-state operation is being carried out.

Though with the embodiment described below, a case where the designs of the cards of a card game are used as the symbols and a matrix card of five rows×five columns is used shall be described as an example, control by the same subroutines is performed even in a case where the designs of mahjong tiles are used as the symbols and a matrix card of a different size is used.

FIG. 13 shows a subroutine for controlling the overall progress of the game.

First, in the process of step S11, whether or not coins or bills have been loaded into the gaming machine is judged. In this process, CPU 66 judges whether or not a signal indicating that the loading of coins or bills has been received from coin and bill detection sensor 58. If CPU 66 judges that this signal has not been received, that is, if it is judged that the player has not loaded coins or bills, the present subroutine is ended immediately without performing any processes, while if it is judged that the above-mentioned signal has been received, that is, if it is judged that the player has loaded coins or bills, a transfer to step S12 is performed.

Next, in the process of step S12, the preparation of a matrix card is performed. In this process, CPU 66 prepares a predetermined number of matrix cards, in each of which the designs of playing cards are aligned in accordance with a lottery. This process shall be described further below. When this process is ended, a transfer to step S13 is performed.

Next, in the process of step S13, the setting of the betting quantity is performed. In this process, CPU 66 urges the player to input the desired betting quantity and the betting quantity for the game is set based on the information input by the player. This process shall be described further below. When this process is ended, a transfer to step S14 is performed.

Next, in the process of step S14, the game is executed. In this process, CPU 66 performs lottery selection of symbols comprising playing card designs one by one and the game progresses accordingly, This lottery is repeated a predetermined number of times and the game ends at the point at which the lottery of the predetermined number of times is ended. These processes shall be described further below. When this process is ended, a transfer to step S15 is performed.

Next, in the process of step S15, the payment of coins is performed. In this process, CPU 66 performs the payment of coins based on the result of the game that was executed in step S14. This process shall be described further below. When this process is ended, a transfer to step S16 is performed.

Next, in the process of step S16, whether or not there are any remaining coins is judged or whether or not any coins won by the player are left is judged. If CPU 66 judges that there still remain coins loaded into gaming machine 10 by the player or coins won by the player, since the playing of a new game will then be possible, a return to step S12 is performed, and if it is judged that there no longer remain any coins loaded into gaming machine 10 by the player or coins won by the player, since the game can no longer be continued in this case, the present subroutine is ended immediately.

[Card Preparation Process]

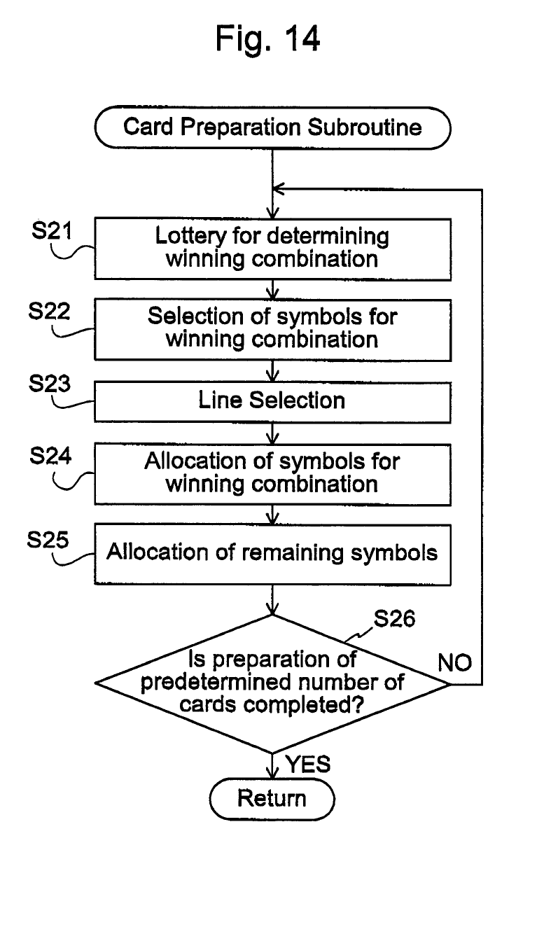

In the above-described step S12, a subroutine such as that shown in FIG. 14 is called.

First in the process of step S21, lottery selection of a winning combination, at least one or more of which will be formed in a matrix card necessarily, is performed. In this process, CPU 66 selects, by lottery, one winning combination from among a determined winning combination list stored in a predetermined location of ROM 68. When this process is ended, a transfer to step S22 is performed.

Next, in the process of S22, the selection of symbols used in the determined winning combination is performed. In this process, CPU 66 performs selection of the symbols used in the determined winning combination that was determined in the above-described step 521. CPU 66 selects the five symbols necessary for arranging this winning combination.

For example, if the determined winning combination is a “royal straight flush,” one mark is selected by lottery from among the four marks of spades, hearts, diamonds, and clubs. Since in the case of this winning combination, the numbers will necessarily be the five numbers of A, K, Q, J, and 10, only the lottery selection of the mark is necessary.

In a case where the determined winning combination is a “full house,” first, one symbol is selected and then two symbols, which are the same in number as the first symbol selected but differ in marks, are selected. Next, a symbol of a number that differs from that of the first symbol is selected and then one symbol that is of the same number but of different mark is then selected. A combination made up of a set of three symbols of the same number and a set of two symbols of the same number that differs from that of the prior set is thus formed.

When the above process is ended, a transfer to step S23 is performed.

Next, in the process of step S23, the line along which the determined winning combination is to be aligned is selected. CPU 66 determines the location of the line along which the combination of symbols, determined in step S22 described above, is to be aligned. CPU 66 performs a lottery selection of which line among the twelve lines of the matrix card the symbols that make up the determined winning combination are to be aligned along and thereby determines a single line. When this process is ended, a transfer to step S24 is performed.

Next, in the process of step S24, the allocating of the symbols that make up the determined winning combination is performed. In this process, CPU 66 aligns the five symbols determined in the above-described step S22 along the line determined in the above-described step S23. CPU 66 determines, by lottery, at which of the five cells along this line each of the five symbols is to be allocated and allocates all of the symbols along this line accordingly. When this process is ended, a transfer to step S25 is performed.

Next, in the process of step S25, the allocating of symbols in the remaining cells is performed. In this process, CPU 66 allocates symbols to the remaining twenty cells in which symbols were not allocated in the above-described step S24. For each of these twenty cells, CPU 66 determines, by lottery, which symbol to be allocated, allocates the symbol selected by lottery to each of these cells, and thus allocates symbols to all twenty five cells of the matrix card. When this process is ended, a transfer to step S26 is performed.

Next, in the process of step S26, whether or not the preparation of the predetermined number of matrix cards has been completed is judged. In this process, CPU 66 judges whether or not the number of matrix cards prepared by the above-described processes of step S21 through step S25 has become equal to the predetermined number of cards. If CPU 66 judges that the predetermined number of matrix cards have not been prepared, a return to step S21 is performed in order to prepare the remaining cards while if it is judged that the predetermined number of matrix cards have been prepared, this subroutine is ended immediately. Since by performing the above-described processes of this subroutine, a plurality of matrix cards are prepared and since by performing the above-described processes of steps S21 to S25, it becomes possible to “allocate symbols to all of the cells of the above-mentioned matrix so that a combination among a plurality of the above-mentioned designs that are winning combinations in a poker game of cards will be aligned in at least one or more of the plurality of lines of the above-mentioned matrix,” a matrix with which no winning combination is formed by the alignment of symbols will not be presented to a player and a player can anticipate the receiving of profit no matter which card he or she selects.

Also in a case where the winning combination selected by lottery in step S21 enables the provision of profit to a player in the form of a quantity of game media disbursed or a multiplication factor of disbursement with respect to the quantity of game media bet by the player of a predetermined standard or more, it becomes possible for the player to always anticipate the receiving of profit of a certain level or more.

[Betting Quantity Setting Process]

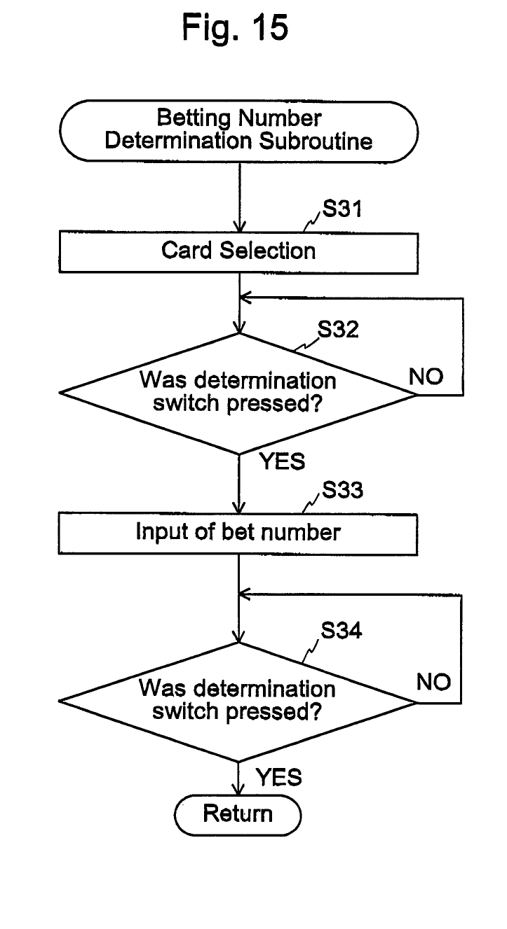

In the above-described step S13, a subroutine such as that shown in FIG. 15 is called.

First in the process of step S31, the card selection screen is displayed. In this process, CPU 66 makes the matrix card selection screen be displayed on display device 32 and makes the player selected one card from among the plurality of cards prepared in step S12. Here,one of the plurality of matrix cards is displayed on display device 32, and with regard to the remaining matrix cards, one card among the other matrix cards is displayed upon being interchanged with the already displayed matrix card when the player presses a selection switch. By repeating this operation, all of the matrix cards prepared in step S12 can be displayed to the player. When this process is ended, a transfer to step S32 is performed.

Next, in the process of step S32, whether or not the determination switch has been pressed is judged. In this process, CPU 66 judges whether or not the player has pressed the determination switch. If CPU 66 has not received a signal indicating that the determination switch has been pressed from the switch, it judges that the player has not yet pressed the determination switch and this step is repeated, and if the signal indicating that the determination switch has been pressed is received from the switch, it is judged that the player has pressed the determination switch and a transfer to step S33 is performed.

Next, in the process of step S33, a betting quantity input screen is displayed. In this process, CPU 66 displays the matrix card, selected in the above-described steps S31 and S32, on display device 32 and displays a screen that urges the player to determine the number of coins to be bet on the matrix card. At this point, in addition to the matrix card, a table, which indicates, for the number of coins bet, the multiplication factors of coins that are returned in accordance with the types of completed winning combinations, is also displayed, and the player determines the number of coins bet by referencing this table.

Though with the present embodiment, the player bets coins on the matrix card, this invention is not limited thereto, and each one of the plurality of lines of the matrix card may be handled as a subject of betting and arrangements can be made to bet coins on each line.

When this process is ended, a transfer to step S32 is performed.

Next, in the process of step S34, whether or not the determination switch has been pressed is judged. In this process, CPU 66 judges whether or not the player has pressed the determination switch after inputting the desired number of coins bet, If CPU 66 has not received a signal indicating that the determination switch has been pressed from the switch, it judges that the player has not yet pressed the determination switch and this step is repeated, and if the signal indicating that the determination switch has been pressed is received from the switch, it is judged that the player has pressed the determination switch and this subroutine is ended immediately.

[Game Execution Process]

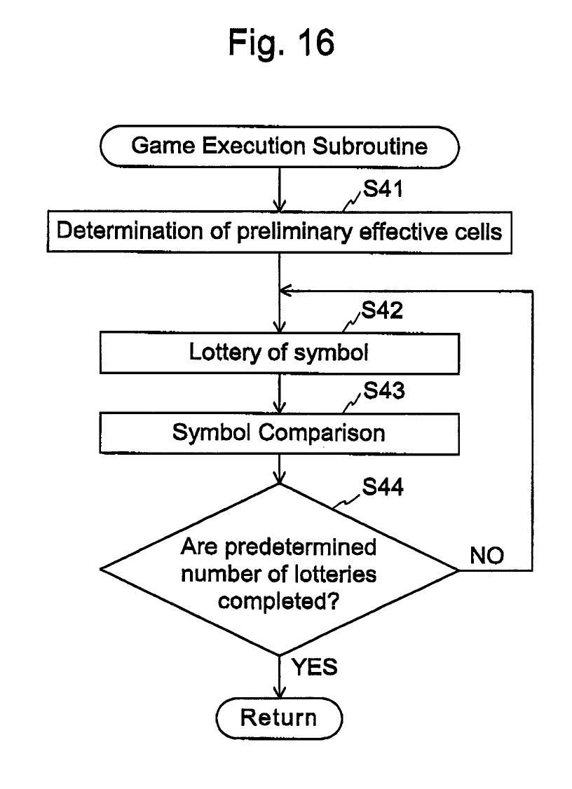

In the above-described step S14, a subroutine such as that shown in FIG. 16 is called.

First in the process of step S41, the determination of priorly effective cells is performed. In this process, CPU 66 performs a lottery for determining cells, among the twenty five cells of the matrix card, that are to be effective from the start of the game. CPU 66 performs a lottery regarding the number and positions of the cells to be made effective, and based on this result, makes effective the cells that are to be made effective. When this process is ended, a transfer to step S42 is performed.

Next, in the process of step S42, lottery selection of a symbol is performed. In this process, CPU 66 selects one symbol by an internal lottery. The selected symbol is then displayed in the list of lottery results displayed at the upper right part of display device 32. If the selected symbol has already been selected once in the same game and is displayed in the above-mentioned list, the lottery result is not displayed and the lottery is performed again so that a new symbol will be selected again. When the above processes are ended, a transfer to step S43 is performed.

Next, in the process of step S43, collation of the symbol is performed. In this process, CPU 66 collates the symbol selected in the above-described step S42 with the symbols displayed in the matrix card that is displayed on display device 32. If the same symbol as the selected symbol is displayed in the matrix card, the cell in which the symbol is displayed is made effective and the color of this cell is changed.

When the above process is ended, a transfer to step S44 is performed.

Next, in the process of step S44, whether or not the lottery has been performed the predetermined number of times is judged. In this process, CPU 66 judges whether or not the lottery selection of a symbol, executed in the above-described step S42, has been executed the predetermined number of times. If CPU 66 judges that the number of times this lottery has been performed has not yet reached the predetermined number of times, a return to step S42 is performed, and if it is judged that the number of times this lottery has been performed has reached the predetermined number of times, this subroutine is ended immediately.

Though with the present embodiment, even if the completion of a winning line among the plurality of lines is achieved prior to the number of times of lottery reaching the predetermined number of times, the lottery is repeated until the number of times of lottery reaches the predetermined number of times, this invention is not limited thereto, and arrangements may be made so that if the completion of a winning line among the plurality of lines is achieved prior to the number of times of lottery reaching the predetermined number of times, the lottery is ended at that point. In this case, the judgment criterion of the process of step S44 will be: “end of the predetermined number of times of lottery or completion of a winning line.”

Also, though with the present embodiment, cells that are deemed to be effective are determined at the start of the game, this invention is not limited thereto, and arrangements may be made so that cells are not made effective at the start of the game. In this case, step S41 is not executed, and in the present subroutine, step S42 is executed first.

[Coin Disbursement Process]

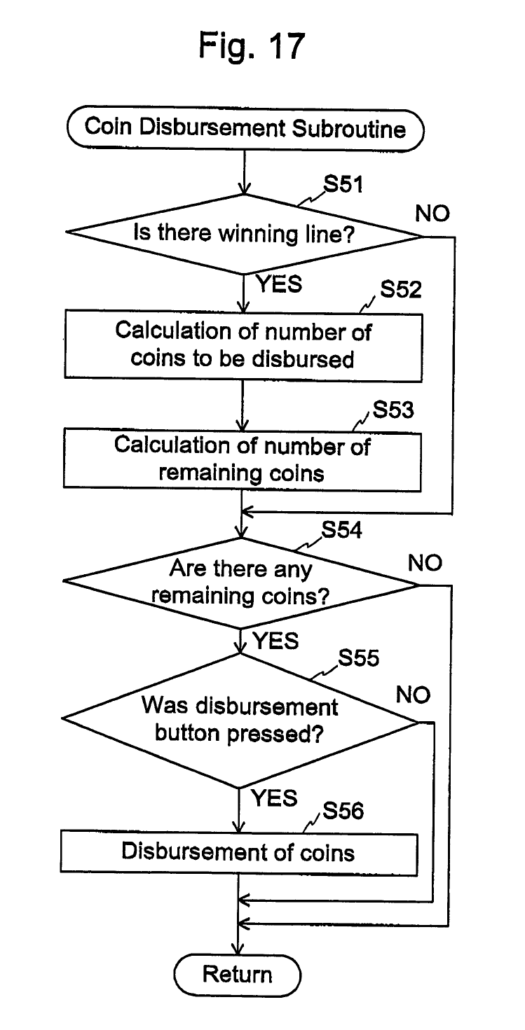

In the above-described step S15, a subroutine such as that shown in FIG. 17 is called.

First, in the process of step S51, whether or not there is a winning line among the plurality of lines in the matrix card is judged. In this process, CPU 66 judges whether or not a line, with which all cells have been made effective and with which a winning combination is formed, exists among the combinations of symbols along the plurality of lines in the matrix card displayed on display device 32. If CPU 66 judges that there are no winning lines among the plurality of lines, a transfer to step S54 is performed while if it is judged that there is a winning line among the plurality of lines, a transfer to step S52 is performed.

Next, in the process of step S52, the number of coins disbursed is calculated. In this process, CPU 66 calculates the number of coins disbursed by multiplying the number of coins bet by the player in the game by the disbursement multiplication factor that is in accordance with the type of winning combination of the line that has been judged to be a winning line in the above-described step S51. Here, if a plurality of winning lines exist, the multiplication factor of the winning combination having the highest disbursement multiplication factor among the respective winning combinations is applied. When the above process is ended, a transfer to step S53 is performed.

Though with the present embodiment, if a plurality of winning lines exist, the multiplication factor of the winning combination having the highest disbursement multiplication factor among the respective winning combinations is applied, this invention is not limited thereto, and arrangements may be made to add the disbursement multiplication factors of all winning combinations and multiply this by the number of coins bet by the player.

Next, in the process of step S53, the summing of the remaining number of coins owned by the player is performed. In this process, CPU 66 adds the number of coins disbursed, which was calculated in the above-described step S52, to the number of coins that the player has loaded in gaming machine 10 but remains without being bet on the game. When this process is ended, a transfer to step S54 is performed.

Next, in the process of step S54, whether or not there are any remaining coins is judged. In this process, CPU 66 judges whether or not any coins reserved in gaming machine 10 remain as a result of the player loading into gaming machine 10 or receiving disbursement by winning in the game. If CPU 66 judges that there are no remaining coins, since the game can then no longer be continued in this case, the present subroutine is ended immediately without performing any other processes, while if it is judged that there are remaining coins, a transfer to step S55 is performed.

Next, in the process of step S55, whether or not the disbursement switch has been pressed is judged. In this process, CPU 66 judges whether or not the player has pressed disbursement switch 48. If CPU 66 has not received a signal indicating that disbursement switch 48 has been pressed from the switch, it judges that the player has not pressed disbursement switch 48 and the present subroutine is ended immediately without performing any other processes, and if the signal indicating that disbursement switch 48 has been pressed is received from the switch, it is judged that the player has pressed disbursement switch 48 and a transfer to step S56 is performed.

Next, in the process of step S56, a coin disbursement process is performed. In this process, CPU 66 sends a signal, for disbursing the total number of coins reserved in the gaming machine 10, that is, the sum of the number of coins that the player loaded into gaming machine 10 but has not been bet on the game and the number of coins won by the player in the game, to disbursement device 82, and upon receiving this signal, disbursement device 82 discharges the total number of coins from coin disbursement slot 52. When the above processes are ended, this subroutine is ended immediately.

By performing the respective control processes described above, a gaming machine, such as a so-called “bingo gaming machine,” in which cells of a matrix allocated to a player are made effective in accordance with a lottery can be made to combine the fun of a “bingo game” of anticipating whether or not a line of effective cells will be completed with the fun of a “poker game” or a “mahjong game” of the quantity of game media disbursed being determined according to a winning combination formed by a combination of symbols indicated by the effective cells, thereby enabling a new way of enjoying a game in which the aim is not just to complete any line among the plurality of lines in a “bingo game” but in which the quantity of game media disbursed is determined by what winning combination a line that is completed has.

[Arrangement of a Server]

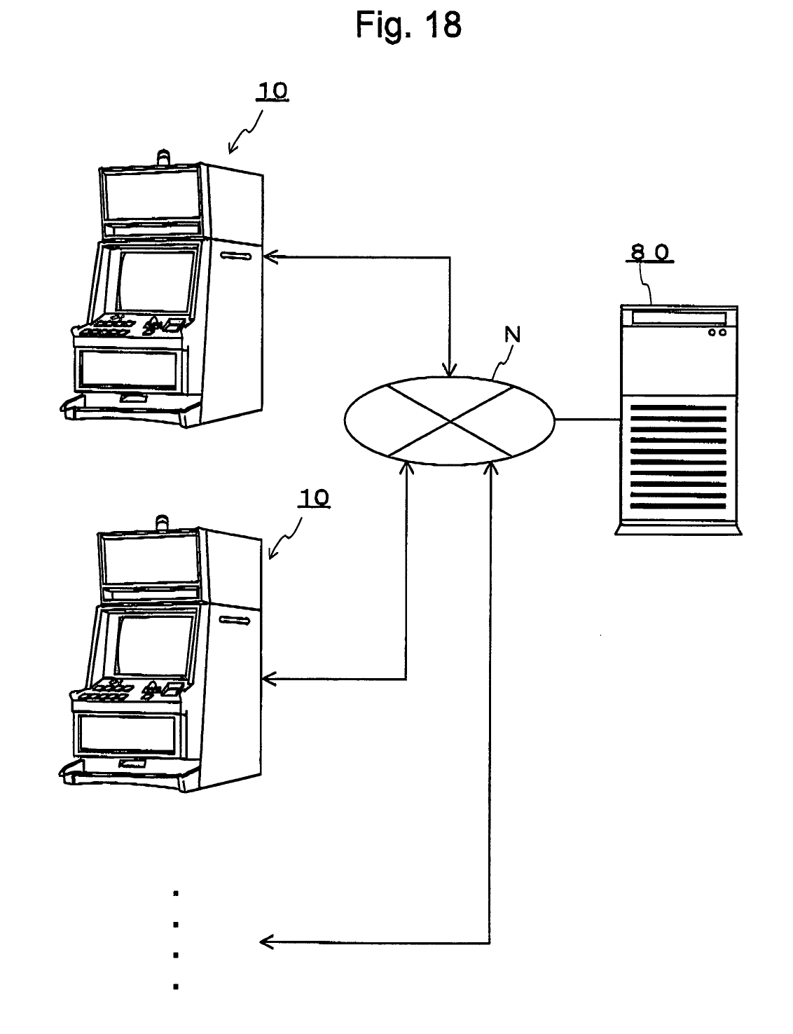

Though the above-described embodiment was arranged with just a gaming machine 10, gaming machines 10 maybe connected to a server 80 and be enabled to perform the sending and receiving of a predetermined information with server 80 as shown in FIG. 18. Specifically, server 80 performs an internal lottery process such as that described above and supplies the internal lottery data to gaming machines 10, which are terminal devices, and each gaming machine 10 may be made to display, upon receiving the internal lottery data, images based on the internal lottery data. Needless to say, server 80 may be arranged to select images to be displayed based on the internal lottery data and supply the image data to gaming machines 10, and each gaming machine 10 maybe made to display, upon receiving the image data, images based on the image data.

That is server 80 controls gaming machines 10 and has the following functions.

(A) A function of “using the designs of a deck of playing cards as the above-mentioned symbols and allocating symbols to all of the cells of the above-mentioned matrix so that a combination among a plurality of combinations of the above-mentioned designs that are winning combinations in a poker game of cards will be aligned in at least one or more of the plurality of lines of the above-mentioned matrix.”

(B) A function of “carrying out a game using the matrix having symbols allocated to all of the above-mentioned cells by the above-mentioned symbol allocating means and, when all cells of a line, made up of cells that indicate a combination of symbols expressing a winning combination in a poker game, become effective, determining, in accordance with the above-mentioned winning combination, the magnitude of disbursement of game media or the multiplication factor of disbursement with respect to the quantity of game media bet by the above-mentioned player”.

(C) A function of “using the designs of a set of mahjong tiles as the above-mentioned symbols and allocating symbols in all of the cells of the above-mentioned matrix so that a combination, among a plurality of combinations of the above-mentioned designs that are winning combinations made up of predetermined combinations of symbols, will be aligned in at least one or more of the plurality of lines of the above-mentioned matrix.”

(D) A function of “carrying out a game using the matrix having symbols allocated to all of the above-mentioned cells by the above-mentioned symbol allocating means and, when all cells of a line, made up of cells that indicate a combination of symbols expressing an above-mentioned predetermined winning combination, become effective, determining in accordance with the above-mentioned winning combination, the magnitude of disbursement of game media or the multiplication factor of disbursement with respect to the quantity of game media bet by the above-mentioned player.”

By thus arranging so that server 80 controls gaming machine 10, a gaming machine, such as a so-called “bingo gaming machine,”in which cells of a matrix allocated to a player are made effective in accordance with a lottery can be made to combine the fun of a “bingo game” of anticipating whether or not a line of effective cells will be completed with the fun of a “poker game” or a “mahjong game” of the proportion of game media returned being determined according to a winning combination formed by a combination of symbols indicated by the effective cells, thereby enabling a new way of enjoying a game in which the aim is not just to complete any line among the plurality of lines in a “bingo game” but in which the disbursement multiplication factor of game media varies according to what winning combination a line that is completed has.

Also, as the terminal devices connected to server 80, personal computers and portable telephones and other portable terminals may be used, and by making server 80 send image data for display, data indicating such image data, audio data, etc. to terminal devices, the fun of a “bingo game” of anticipating whether or not a line of effective cells will be completed can be combined with the fun of a “poker game” or a “mahjong game” of the proportion of game media returned being determined according to a winning combination formed by a combination of symbols indicated by the effective cells, thereby enabling a new way of enjoying a game in which the aim is not just to complete any line among the plurality of lines in a “bingo game” but in which the disbursement multiplication factor of game media varies according to what winning combination a line that is completed has.

Furthermore, by an arrangement such as shown in FIG. 18, even when a plurality of gaming machines 10 are installed at locations of distances that do not enable the sending and receiving of data by a single cable from a plurality of servers 80 or even when a plurality of gaming machines are installed at locations that are separated from each other, the plurality of gaming machines 10 can be controlled in an integral manner via a public telephone line network or other communication line.

Also, the effects indicated in the present specification are just the most favorable effects arising from this invention, and the effects of this invention are not limited to those indicated in this specification.

With the present invention, by arranging a gaming machine, such as a so-called “bingo gaming machine,” in which cells of a matrix assigned to a player are made effective in accordance with a lottery, so as to “have a symbol allocating means, which uses the designs of a deck of playing cards as the above-mentioned symbols and allocates symbols to all of the cells of the above-mentioned matrix so that a combination among a plurality of the above-mentioned designs that are winning combinations in a poker game of cards will be aligned in at least one or more of the plurality of lines of the above-mentioned matrix; and a disbursement value determination means, which carries out a game using the matrix having symbols allocated to all of the above-mentioned cells by the above-mentioned symbol allocating means and, when all cells of a line, made up of cells that indicate a combination of symbols that express a winning combination in a poker game, become effective, determines, in accordance with the above-mentioned winning combination, the magnitude of disbursement of game media or the multiplication factor of disbursement with respect to the quantity of game media bet by the above-mentioned player,” the fun of a “bingo game” of anticipating whether or not a line of effective cells will be completed can be combined with the fun of a “poker game” of the quantity of game media disbursed is determined according to a winning combination formed by a combination of symbols indicated by the effective cells, thereby enabling a new way of enjoying a game in which the aim is not just to complete any line among the plurality of lines in a “bingo game” but in which the quantity of game media disbursed is determined by what winning combination a line that is completed has.

What is claimed is:

1. A gaming machine with which a combination-making game is performed, the combination-making game using a matrix which comprises a row with a row cell number of at least two and a column with a column cell number of at least two, wherein the row cell number equals the column cell number so as to constitute the matrix containing a plurality of cells, each of which has an allocated symbol such that each corresponding cell becomes effective if the allocated symbol to the corresponding cell is selected by a main lottery, the gaming machine being characterized to provide a benefit to a player depending on a pattern of cells being effective after a predetermined number of main lotteries, the gaming machine comprising:
a symbol allocating means for allocating symbols to the respective cells such that at least one combination being composed of a same number of symbols as the row or column cell number matches a first predetermined winning combination with a first predetermined rank of the combination-making game under a predetermined condition so that the at least one combination is aligned along a first line among lines contained in the matrix; and
a disbursement value determination means for determining amount of disbursement or a multiple number of a bet number of bets made by the player for disbursement depending on the first predetermined rank of the combination of the combination-making game if all cells with allocated symbols along the first line so as to make the first winning combination become effective after the predetermined number of lotteries are made with the matrix having symbols allocated to the respective cells thereof.

2. The gaming machine according to claim 1, wherein the combination-making game comprises a poker game and the row cell number of the matrix is five.

3. The gaming machine according to claim 1, wherein the combination-making game comprises a mahjong game.

4. The gaming machine according to claim 1, further comprising a betting means for betting game media in regard to the matrix;
wherein the first winning combination that is aligned along the first line and is composed of symbols allocated by said symbol allocating means causes the gaming machine to provide a benefit to the player and the benefit, which is more than a predetermined standard, is based on a disbursable number of the game media or the multiple number of the bet number of the game media the player has bet.

5. The gaming machine according to claim 2, further comprising a betting means for betting game media in regard to the matrix;
wherein the first winning combination that is aligned along the first line and is composed of symbols allocated by said symbol allocating means causes the gaming machine to provide a benefit to the player and the benefit, which is more than a predetermined standard, is based on a disbursable number of the game media or the multiple number of the bet number of the game media the player has bet.

6. The gaming machine according to claim 3, further comprising a betting means for betting game media in regard to the matrix;
wherein the first winning combination that is aligned along the first line and is composed of symbols allocated by said symbol allocating means causes the gaming machine to provide a benefit to the player and the benefit, which is more than a predetermined standard, is based on a disbursable number of the game media or the multiple number of the bet number of the game media the player has bet.

7. The gaming machine according to claim 4,
wherein said symbol allocating means allocates symbols to the respective cells of the matrix such that the matrix contains a second line being constituted of a second combination with a second rank of the combination-making game;
wherein said betting means allows the player to bet game media on the first and/or second lines; and
wherein the gaming machine comprises an effective line determination means for determining whether the first and/or second lines are applicable to disbursement of game media in accordance with a bet number of game media the player has bet if all cells of the first and second lines become effective.

8. The gaming machine according to claim 1, further comprising a preliminary cell validation means for making at least one cell contained in the matrix effective in accordance with a result of a preliminary lottery performed prior to said main lottery.

9. The gaming machine according to claim 2, further comprising a preliminary cell validation means for making at least one cell contained in the matrix effective in accordance with a result of a preliminary lottery performed prior to said main lottery.

10. The gaming machine according to claim 3, further comprising a preliminary cell validation means for making at least one cell contained in the matrix effective in accordance with a result of a preliminary lottery performed prior to said main lottery.

11. The gaming machine according to claim 4, further comprising a preliminary cell validation means for making at least one cell contained in the matrix effective in accordance with a result of a preliminary lottery performed prior to said main lottery.

12. The gaming machine according to claim 5, further comprising a preliminary cell validation means for making at least one cell contained in the matrix effective in accordance with a result of a preliminary lottery performed prior to said main lottery.

13. A program used in a gaming machine with which a combination-making game is performed, the combination-making game using a matrix which comprises a row with a row cell number of at least two and a column with a column cell number of at least two, wherein the row cell number equals the column cell number so as to constitute the matrix containing a plurality of cells, each of which has an allocated symbol such that each corresponding cell becomes effective if the allocated symbol to the corresponding cell is selected by a main lottery, the gaming machine being characterized to provide a benefit to a player depending on a pattern of cells being effective after a predetermined number of main lotteries, the program comprising the steps of:
creating the matrix having symbols allocated to the respective cells such that at least one combination being composed of a same number of symbols as the row or column cell number matches a predetermined winning combination with a predetermined rank of the combination-making game under a predetermined condition so that the at least one combination is aligned along a line among lines contained in the matrix;
storing cells of the matrix being made effective by the predetermined number of main lotteries; and
determining amount of disbursement or a multiple number of a bet number of bets made by the player for disbursement depending on the predetermined rank of the winning-stored combination of the combination-making game if the stored cells form the winning-stored combination.

14. The program according to claim 13, wherein the combination-making game comprises a poker game and the row cell number of the matrix is five.

15. The program according to claim 13, wherein the combination-making game comprises a mahjong game.

16. A server, connectable via a communication line to gaming machines, with each of which a combination-making game is performed, the combination-making game using a matrix which comprises a row with a row cell number of at least two and a column with a column cell number of at least two, wherein the row cell number equals the column cell number so as to constitute the matrix containing a plurality of cells, each of which has an allocated symbol such that each corresponding cell becomes effective if the allocated symbol to the corresponding cell is selected by a main lottery, each gaming machine being characterized to provide a benefit to a player depending on a pattern of cells being effective after a predetermined number of main lotteries, the server comprising:
a symbol allocating means for allocating symbols to the respective cells such that at least one combination being composed of a same number of symbols as the row or column cell number matches a predetermined winning combination with a predetermined rank of the combination-making game under a predetermined condition so that the at least one combination is aligned along a line among lines contained in the matrix; and
a disbursement value determination means for determining amount of disbursement or a multiple number of a bet number of bets made by the player for disbursement depending on the predetermined rank of the combination of the combination-making game if all cells with allocated symbols along the first line so as to make the winning combination become effective after the predetermined number of lotteries are made with the matrix having symbols allocated to the respective cells thereof.

17. A gaming machine being connected to the server according to claim 16 via said communication line, comprising:
communicating means for communicating via said communication line with the server and
displaying means for displaying progress of the game to the player.
